(19) United States
(12) Patent Application Publication
(10) Pub. No.: US 2016/0380467 A1
(43) Pub. Date: Dec. 29, 2016

(54) MANAGING THE OUTPUT POWER OF A WIRELESS CHARGER

(71) Applicants: Lei Shao, Sunnyvale, CA (US); Xintian Eddie Lin, Mountain View, CA (US); Songnan Yang, San Jose, CA (US)

(72) Inventors: Lei Shao, Sunnyvale, CA (US); Xintian Eddie Lin, Mountain View, CA (US); Songnan Yang, San Jose, CA (US)

(21) Appl. No.: 14/871,665

(22) Filed: Sep. 30, 2015

Related U.S. Application Data
(60) Provisional application No. 62/185,547, filed on Jun. 26, 2015.

(51) Int. Cl. H02J 7/02; H02J 7/04; H02J 5/00

(52) U.S. Cl. CPC H02J 7/025; H02J 5/005; H02J 7/042

(57) ABSTRACT

Apparatuses and methods for wirelessly charging electronic devices are provided. The apparatuses and methods disclosed herein may wirelessly charge electronic devices by causing a power distribution device to send a group short beacon signal to a plurality of micro-PTU-coils; identifying a load on a first micro-PTU-coil of the plurality of micro-PTU-coils using a detected magnetic flux caused by an object being proximate to the first micro-PTU-coil; determining a location of the object using the identified load on the first micro-PTU-coil; causing the power distribution device to send a group long beacon signal to the plurality of micro-PTU-coils; receiving, from the object, an advertisement, the advertisement comprising an indication of a coupling strength between the first micro-PTU-coil and the object; determining that the object is an electronic device; and determining to apply a current to the first micro-PTU-coil using the location of the electronic device and the coupling strength data.

### CROSS REFERENCE TO RELATED APPLICATION

This application claims the benefit of U.S. Patent Application No. 62/185,547 filed on Jun. 26, 2015, the disclosure of which is incorporated herein by reference as set forth in full.

### TECHNICAL FIELD

This disclosure generally relates to charging systems, and more particularly to systems and methods for managing the output power of a wireless charger.

### BACKGROUND

Mobile devices have become an integral part of the computing landscape. As mobile devices become more capable, they have shifted to perform tasks that have traditionally been performed by non-mobile computers. In one example, mobile devices may have the ability to stream media, display videos, or otherwise process large amounts of data over the course of a day. The increasing use of mobile devices by consumers, along with the high dynamic range of power consumption across mobile devices, may cause certain components of the mobile device to wear down, such as the battery or power source. In some instances, certain applications of mobile devices may consume large portions of the battery powering the mobile device, resulting in a frequent need to charge the mobile device. Consumers may also have multiple mobile devices that may need to be charged, but may only have a limited amount of time to do so. Furthermore, depending on the number of devices a user needs to charge, the user may need as many electrical outlets as there are devices. Given the location of the electrical outlets, the user may have to charge the devices in locations that are not collocated, resulting in the user constantly having to get up to check the status of their devices.

Recent developments in wireless charging technology enable a user to collocate multiple devices on, or near, a wireless charging station (e.g., a table surface with embedded wireless charging coils). In some embodiments the wireless charging coils may be inductive micro-Power Transfer Unit-coils (micro-PTU-coils) in or on a Power Transfer Unit (PTU). Several wireless charging protocols exist (e.g., The Alliance for Wireless Power (A4WP) Rezence Baseline System Specification Version 1.2 (BSS V1.2), published Jul. 28, 2014) for wirelessly charging mobile devices. Although wireless charging stations provide users with the positional freedom to collocate different devices in a single area without having to worry about the number of available outlets, they do suffer from complications that traditional methods of charging (i.e., an electrical outlet) do not suffer from. For example, if an unregistered device is placed on top of the wireless charging station, existing wireless charging technologies will turn off the entire wireless charging station, thereby disabling power to all devices wirelessly connected to the wireless charging station. As a result, the user must remove the unregistered device, before charging can resume. For example, a user may have a wireless charging station embedded in a table, and the user may place one or more non-chargeable objects (e.g., hard drive, DVD, wallet, keychain, book, a pen, etc.) on the surface of the table along with a mobile phone. Existing wireless charging protocols may not charge the mobile phone while the non-chargeable objects are on the surface of the table, which may be undesirable and disruptive to the user's experience, as well as potentially introducing certain power inefficiencies.

### BRIEF DESCRIPTION OF THE FIGURES

Reference will now be made to the accompanying drawings, which are not necessarily drawn to scale, and wherein:

FIG. 1 is an illustrative schematic diagram of an example environment of a charging system, in accordance with example embodiments of the disclosure.

FIG. 2 is an illustrative diagram of an example environment of a PTU, in accordance with example embodiments of the disclosure.

FIG. 3 is an illustrative schematic diagram of an example PTU, in accordance with example embodiments of the disclosure.

FIG. 4 is an illustrative state transition diagram of an example PTU, in accordance with example embodiments of the disclosure.

FIG. 5 is an illustrative sequence diagram of an example group short beacon sequence for detecting load variation, in accordance with certain example embodiments of the disclosure.

FIG. 6 is an illustrative sequence diagram of a long beacon sequence for detecting load variation of small devices, in accordance with certain example embodiments of the disclosure.

FIG. 7 is a flow diagram illustrating an example dataflow for sequence diagrams FIGS. 5 and 6, in accordance with certain example embodiments of the disclosure.

### DETAILED DESCRIPTION OF EMBODIMENTS OF THE DISCLOSURE

The disclosure describes embodiments more fully hereinafter with reference to the accompanying drawings, in which example embodiments are disclosed. This disclosure may, however, be embodied in many different forms and should not be construed as limited to the example embodiments set forth herein; rather, these embodiments are provided so that this disclosure will be thorough and complete, and will fully convey the scope of the disclosure to those skilled in the art. Like numbers refer to like, but not necessarily the same or identical, elements throughout.

Example embodiments of the disclosure may provide systems and methods for detecting a variation in the load experienced by an exemplary PTU (PTU) that provides power to wireless charging mobile devices (also referred to herein as (PRUs)), such as, but not limited to, mobile communication devices, laptops, smartphones, tablets, internet of things devices, such as appliances, wearables (including headsets, watches, health monitors, etc.) or other mobile devices. Example embodiments may include one or more PRUs electromagnetically coupled to a PTU. The PTU may be configured to wirelessly (i.e., electromagnetically) charge, or provide power defined as energy per unit time, to one or more connected PRUs. The PTU may be comprised of, amongst other things, two or more non-overlapping or partially overlapping coils, which in an illustrative embodiment may be micro-PTU-coils. The two or more non-overlapping or partially overlapping micro-PTU-coils may provide power to the one or more PRUs using examples described herein, which include but are not limited to, capacitive charging, inductive charging, and other wireless charging methods. The PTU may provide power to the one or more PRUs when the one or more PRUs are placed near one or more of the non-overlapping or partially overlapping micro-PTU-coils. The word near as used herein may refer to the infinite number of points between furthest distance and closest distance at which two or more non-overlapping or partially overlapping micro-PTU-coils on/in a PTU and one or more micro-PTU-coils on/in one or more PRUs may be magnetically coupled to one another. The closest distance may be a distance at which the one or more micro-PTU-coils on/in the PTU and the one or more coils on/in the PRUs are in direct contact with one another. The furthest distance may be a distance at which a magnetic field in the micro-PTU-coils of the PTU induces a magnetic flux in the coils of the PRUs sufficient to generate at least one electric charge in the coils of the PRUs. Wherein the magnetic field in the micro-PTU-coils of the PTU may be generated in response to a current passing through the micro-PTU-coils. A battery in the PTU may generate the current. Similarly, the furthest distance may be a distance at which a magnetic field in the coils of the PRUs induces a magnetic flux sufficient to generate at least one electric charge in the micro-PTU-coils of the PTU. Wherein the magnetic field in the coils of the PRU may be generated in response to a current passing through the coils. A battery in each of the PRUs may generate the current.

The one or more micro-PTU-coils in the PTU and PRUs may be magnetically coupled to one another when a magnetic field generated in the one or more micro-PTU-coils in the PTU induces a magnetic field and corresponding current in the coils of the PRUs. The one or more micro-PTU-coils in the PTU and PRUs also may be magnetically coupled to one another when a magnetic field generated in the one or more coils in the PRUs induce a magnetic field and corresponding current in the micro-PTU-coils of the PTU. The PTU may implement or otherwise include magnetic resonance technology to wirelessly charge, or distribute power, to connected PRUs. However, one or more interfering objects (e.g., portable hard drive, DVD, wallet, or keychain) may be positioned on one or more of the micro-PTU-coils thereby preventing a PRU, positioned on or near a covered coil, from being properly charged. Furthermore, the one or more objects could pose a safety risk to the user if the one or more interfering objects are comprised of flammable material that may be ignited by the magnetic resonance (or resulting heat) created by the one or more micro-PTU-coils in the PTU.

A PTU in accordance with the present disclosure may, distinguish between the one or more PRUs and one or more interfering objects by using a wireless charging protocol. The wireless charging protocol may detect interfering objects and then turn off the micro-PTU-coils covered by the one or more interfering objects, and turn on and/or keep on the micro-PTU-coils covered by PRUs. The wireless protocol described herein may charge multiple PRUs while providing a user positional freedom to place their PRUs in any location on a charging surface of a PTU according to the present disclosure where there is an unoccupied coil. The wireless protocol is comprised of a scanning and a charging module. The scanning module may detect the location of interfering objects and PRUs relative to one or more micro-PTU-coils in, or on, the PTU. The charging module may power off and power on the micro-PTU-coils, and in particular, power off the micro-PTU-coils covered by interfering devices when the scanning module determines which micro-PTU-coils have an interfering object proximate to it.

As mentioned above, when an interfering object is placed on top of a PTU with a single coil, the charging protocol may instruct the PTU to disable the entire PTU, which may be undesirable. In contrast, the present disclosure describes systems and methods for managing the output power of a PTU having multiple non-overlapping or partially overlapping micro-PTU-coils, which use multiple charging micro-PTU-coils to increase the charging surface area over which PRUs may be charged. The present disclosure also describes systems and methods for enabling a portion, or entire area of a surface area of a PTU, by selectively powering on one or more micro-PTU-coils that are closest to the PRU, and that provide the correct power requirements for the PRU. The present disclosure also describes systems and methods for disabling, or not turning on, a portion, or entire area of the surface area of a PTU, by scanning the micro-PTU-coils for interfering objects, and disabling the coil(s) with an interfering object covering the coil. If an interfering object is placed on the coil before a coil is activated, the PTU may scan the micro-PTU-coils, detect the interfering object, and will not enable the coil while an interfering object is covering it.

One or more scanning and charging functions of the scanning modules and charging modules, may be implemented by sending periodic electromagnetic signals (i.e., electromagnetic beacons) from one or more micro-PTU-coils to one or more coils in a PRU. The periodic electromagnetic beacons may also be referred to as periodic beacon signals. The periodic beacon signals may be selectively emitted from one or more of the micro-PTU-coils, based on a current and/or voltage that is selectively routed to the one or more micro-PTU-coils from the scanning and/or charging modules via an electrical switch. The PTU may emit the periodic beacon signals to determine the best coil to pair with the PRU. The PTU may also send periodic radio frequency signals using a wireless radio internal to the PTU to the PRU requesting power consumption information about the PRUs from the PRUs. In particular, a PTU disclosed herein may send periodic beacon signals to one or more PRUs on a surface of the PTU to detect the presence of the PRUs. A PRU proximate to the PTU may receive the signal(s) (e.g., a beacon), and in response, send one or more signals to the PTU, which signals may be used by the PTU to determine the best coil on the surface of the PTU to pair with the PRU. The PTU may send the signals to the PRU using the scanning module. In particular, a scanning module may generate one or more electrical waveforms, using a DC and/or AC power source, in response to one or more processors executing one or more computer-readable instructions stored in memory. The scanning module may comprise a power amplifier that may use the current, voltage, and/or power (real and/or reactive) of a DC and/or AC power source to generate the one or more waveforms. The one or more waveforms may have a predetermined shape, wherein the shape may be determined by the one or more computer-readable instructions stored in memory indicating what the approximate shape of the waveform may be to detect a type of PRUs. For example, a first waveform may be generated to detect larger PRUs (e.g., laptops, tablets, mobile phones) and a second waveform may be generated to detect smaller PRUs (e.g., wrist watch, heart-strap monitor). The predetermined shape may also be determined by, one or more computer-readable instructions stored in memory indicating what the best micro-PTU-coils on/in the PTU are to pair with one or more coils in the PRUs, in response to the type of PRU detected. In some embodiments, the best coil on the surface of the PTU to pair with a PRU may be based on the shortest distance between the PRU and a coil adjacent the surface of the PTU. In other embodiments, the best coil may be determined at least in part on the power supplied by a coil. Yet in other embodiments, the best coil may be based at least in part on the power supplied by a coil and the distance between the coil and the PRU.

The systems and methods disclosed herein enable PTUs to activate a particular area of a surface of the PTU to charge PRUs by selectively powering one or more micro-PTU-coils of a plurality of micro-PTU-coils that offer the appropriate power to the PRUs, while not providing power to micro-PTU-coils with non-chargeable objects proximate to them. The disclosed systems and methods enable PTUs to more efficiently consume power by, for example, only providing power to the micro-PTU-coils that have PRUs coupled to them. These systems and methods also increase the number of PRUs that can be charged by, coupling each PRU, to a coil that has power selectively applied it. In contrast, wireless charging protocols that use only one coil centrally located in the PTU may not charge as efficiently PRUs further from the coil as compared to PRUs located closer to the coil. The PTUs and PRUs overcome this problem and other problems associated with a single coil charger using the methods and systems disclosed herein. The wireless protocol and multiple non-overlapping or partially overlapping micro-PTU-coils included in the PTU increases the active surface area over which a user can charge multiple PRUs.

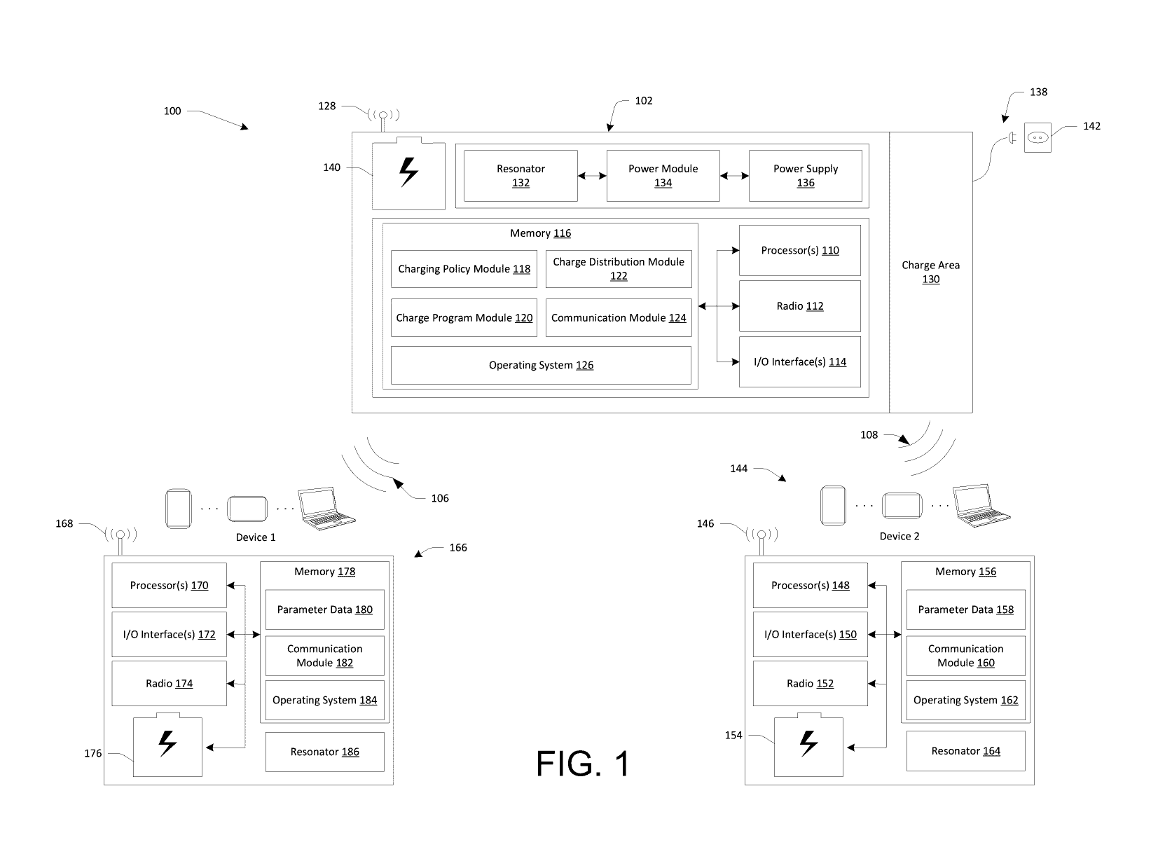

Some example elements involved in the operation of the systems, methods, and apparatus disclosed herein may be better understood with reference to the figures. Referring now to FIG. 1, FIG. 1 is a simplified schematic diagram illustrating an example wireless charging environment 100 in accordance with embodiments of the disclosure. FIG. 1 depicts a wireless charging device, that is, a PTU (PTU 102), a first mobile device (e.g., Device 1), that is, a first PRU (PRU 166), and a second mobile device (e.g., Device 2), that is, a second Power Receiving Unit (PRU 144). This embodiment is merely illustrative, because any number of PRUs may be included. PTU 102, PRU 166, PRU 144, and charging policy configurator 400 may be in wireless communication with PTU 102 via wireless links 106 and 108 respectively. Specifically, PRU 166 may be wirelessly connected to PTU 102 via wireless link 106. PRU 144 may be wirelessly connected to PTU 102 via wireless connection 108. In other embodiments of the present disclosure, additional or fewer PRUs and/or PTUs may be included.

PTU 102 may be any suitable device configured to wirelessly charge connected PRUs 166, 144. In some embodiments, PTU 102 may incorporate, at least in part, a standardized charging protocol, such as that established by the Alliance for Wireless Power (A4WP). In the illustrated embodiment, PTU 102 may include one or more processor(s) (e.g., Processor(s) 110), a wireless radio (e.g., radio 112), and one or more input/output interfaces (e.g., (I/O) Interface(s) 114). Processor(s) 110, radio 112, (I/O) Interface(s) 114 may be communicatively coupled to a memory (e.g., memory 116). Memory 116 may include a charging policy module (e.g., charging policy module 118), a charge program module (e.g., charge program module 120), a charge distribution module (e.g., charge distribution module 122), and a communication module (e.g., communication module 124). Charging policy module 118 may be configured to receive and/or store charging polices from charging policy configurator 400. In some instances, charging policy module 118 may be configured to receive charging policies and/or charging rules, as discussed herein, from a user of PTU 102.

Charge program module 120 may be configured to determine charge programs for connected PRUs. Charge program module 120 may determine one or more charge programs based on one or more messages received wirelessly from one or more PRUs providing the voltage, current, power (real and/or reactive), power factor, status, and/or temperature rating of the one or more PRUs. The one or more messages may be received wirelessly at PTU 102 via antenna 128 and radio 112 from one or more PRUs (e.g., PRU 166's antenna 168 and radio 174 and PRU 144's antenna 146 and radio 152). Radio 112 may receive the one or more messages using a bidirectional low power wireless communication protocol (e.g., Bluetooth Low Energy Profile protocol) operating on one or more frequencies in the 2.4 GHz band. In some embodiments, the one or more charge programs may be programs cached in charging policy module 118 for the one or more PRUs previously charged by PTU 102. In other embodiments, charge program module 120 may determine that a charge program is unavailable for a PRU if resonator 132, power module 134, and power supply 136 are unable to provide the voltage, current, power, and/or power factor within a given temperature rating to the PRU. For example, resonator 132, power module 134, and power supply 136 may provide a predetermined voltage, current, power, and/or power factor within a predetermined temperature range that the PRU may determine it may not be able to use to charge its rechargeable power supply.

Charge distribution module 122 may be configured to control the distribution power to the micro-PTU-coils of PTU 102, which then supplies power to the designated PRUs. Communication module 124 may be configured to transmit and/or receive wireless communications as described herein using a bidirectional low power wireless communication protocol (e.g., Bluetooth Low Energy Profile protocol). PTU 102 may include an operating system (operating system 126) in some embodiments. Operating system 126 may provide users with a guided user interface and/or may provide software logic used to control PTU 102. In some embodiments, one or more of the modules stored on memory 116 of PTU 102 may be stored remotely, for example at a remote server, in the cloud. The remote server may be wirelessly connected to PRUs and PTU 102 in order to receive and/or transmit instructions.

PTU 102 may include an antenna (e.g., antenna 128) in communication with a radio (e.g., radio 112). PTU 102 may also include a resonator (e.g., resonator 132), power module (e.g., power module 134), and a power supply (e.g., power supply 136). Power module 134 may be electrically coupled with power supply 136 and resonator 132. PTU 102 may be connected to an external power source 138 from which PTU 102 may receive energy. In other embodiments, PTU 102 may receive power from a solar cell and/or piezoelectric device connected to PTU 102. PTU 102 may further include a battery (e.g., battery 140) or another energy storage device that may be configured to, store power received from external power source 138. Although each of these components is shown in the illustrated embodiment, other embodiments may include additional or fewer components. For example, PTU 102 may include capacitive charging technology, contact ultrasound or non-contact ultrasound technology, infrared technology, or other wireless power distribution technologies. PTU 102 may come in any shape, size, or form. For example, PTU 102 may be in the form of, or include, a mat or a sheet, or may be integrated into furniture such as tables or desktops, walls, airplane seats, chairs, armrests, electronic devices such as laptops or computers, or other surfaces adjacent at which PRUs may be placed. PTU 102 may have a designated physical location that provides charging to mobile devices positioned within the location, referred to herein as charge area 130. Charge area 130 may include one or more indicators, for example LED lights, indicating different charging locations across charge area 130. The one or more indicators may be color-coded or may otherwise provide location or connectivity information (e.g., one LED may be illuminated for each connected device to approximate the location where the coil charging each mobile device is located in charge area 130) for a user.

Charge area 130 may comprise, among other things not depicted in FIG. 1, one or more non-overlapping micro-PTU-coils. The non-overlapping micro-PTU-coils may have a specific geometry different or varying geometry. In some embodiments, a subset of the non-overlapping micro-PTU-coils may have a different geometry than the other non-overlapping micro-PTU-coils in the PTU. For example, if the shape and size of charge area 130 is limited to certain dimensions, the shape of the micro-PTU-coils may differ in size and geometry to maximize the number of micro-PTU-coils provided by PTU 102. The geometry of the micro-PTU-coils may also be based on the type of PRUs that may be charged on PTU 102. For example, the geometry of a subset of the non-overlapping micro-PTU-coils may be circles, but the geometry of another subset of non-overlapping micro-PTU-coils may rectangular.

PRUs 166 and 144 may be any device configured to execute one or more applications, software, and/or instructions to provide one or more services to a PTU. PRUs 166 and 144, as used herein, may be any variety of client devices, electronic devices, communications devices, and/or other user devices. PRUs 166 and 144 may include, but are not limited to, tablet computing devices, electronic book (ebook) readers, netbook computers, Ultrabook™ notebook computers, laptop computers, desktop computers, watches or other wearables, health monitors, personal digital assistants (PDA), smart phones, web-enabled televisions, video game consoles, set top boxes (STB), or the like. While the drawings and/or specification may portray PRUs 144, 166 in the likeness of a smartphone, tablet, or laptop computer, the disclosure is not limited to such. Indeed, the systems and methods described herein may apply to any PRU or user device capable of communicating with and/or receiving power from PTU 102. The PRUs disclosed herein may be used by users for a variety of purposes, including, but not limited to, functionality such as web browsing, business functions, communications, graphics, word processing, publishing, spreadsheets, databases, gaming, education, entertainment, media, project planning, engineering, drawing, or combinations thereof.

In the illustrated embodiment, the PRU 166 may include one or more processor(s) (e.g., Processor(s) 170), an input/output interface (e.g., I/O Interface(s) 172), a radio (e.g., Radio 174), and a battery (e.g., Battery 176). Processor(s) 170, I/O Interface(s) 172, Radio 174, Battery 176 may be communicatively coupled to a memory (e.g., memory 178). PRU 166 further may include an antenna (e.g., antenna 168) in communication with Radio 174. Memory 178 may include an application providing charge parameter data (e.g., Parameter Data 180) to Charge Program Module 120. Parameter Data 180 may include static parameter and dynamic parameter data. Static parameter data may include status data about PRU 166. Dynamic parameter data may include voltage, current, power (real and/or reactive), power factor, and/or temperature data that may be used to charge PRU 166. Processor(s) 170 may execute one or more computer-readable operating system (e.g., Operating System 184) instructions to send the static parameter and dynamic parameter data using a communication module (e.g., Communication Module 182) to Charge Program Module 120 via Communication Module 124. As explained above, Charge Program Module 120 may use static and dynamic data to determine a charge program for PRU 166. Processor(s) 170, I/O Interface(s) 172, Radio 174, Communication Module 182, Operating System 184, Resonator 186, and Battery 176 may perform one or more of the same functions as Processor(s) 110, I/O Interface(s) 114, Radio 112, Communication Module 124, Operating System 126, Resonator 132, and Battery 140. Processor(s) 170, I/O Interface(s) 172, Radio 174, Communication Module 182, Operating System 184, Resonator 186, and Battery 176 may also perform one or more functions not performed by Processor(s) 110, I/O Interface(s) 114, Radio 112, Communication Module 124, Operating System 126, Resonator 132, and Battery 140. Operating system 184 may provide users with a guided user interface and/or may provide software logic used to control PRU 166. Resonator 186 may be configured to receive resonant magnetic inductive energy wirelessly from resonator 132 of PTU 102, and may be further configured to charge the battery 176, as described herein. Although each of these components is shown in the illustrated embodiment, other embodiments may include additional or fewer components. In other embodiments, PRU 166 may include components necessary to receive and store other forms of wirelessly communicated energy, such as capacitive charging.

Similarly, PRU 144 may include one or more processor(s) (e.g., processor(s) 148, an input/output interface (e.g., I/O Interface(s) 150, a radio (e.g., Radio 152), and a battery (e.g., Battery 154). Processor(s) 148, I/O Interface(s) 150, Radio 152, and Battery 154 may be communicatively coupled to a memory 156. PRU 144 may further include an antenna (e.g., antenna 146) in communication with Radio 152. Memory 156 may include an application providing charge parameter data (e.g., Parameter Data 158) to Charge Program Module 120. Parameter Data 158 may include static parameter and dynamic parameter data. Static parameter data may include status data about PRU 144. Dynamic parameter data may include voltage, current, power (real and/or reactive), power factor, and/or temperature data that may be used by PTU 102 to charge PRU 144. Processor(s) 148 may execute one or more computer-readable operating system (e.g., Operating System 162) instructions to send the static parameter and dynamic parameter data using a communication module (e.g., Communication Module 160) to Charge Program Module 120 via Communication Module 124. As explained above, Charge Program Module 120 may use static and dynamic data to determine a charge program for PRU 144. Processor(s) 148, I/O Interface(s) 150, Radio 152, Communication Module 160, Operating System 162, Resonator 164, and Battery 154 may perform one or more of the same functions as Processor(s) 110, I/O Interface(s) 114, Radio 112, Communication Module 124, Operating System 126, Resonator 132, and Battery 140. Processor(s) 148, I/O Interface(s) 150, Radio 152, Communication Module 160, Operating System 162, Resonator 164, and Battery 154 may also perform one or more functions not performed by Processor(s) 110, I/O Interface(s) 114, Radio 112, Communication Module 124, Operating System 126, Resonator 132, and Battery 140. Operating system 162 may provide users with a guided user interface and/or may provide software logic used to control PRU 144. PRU 144 may also include resonator 164 configured to receive resonant magnetic inductive energy wirelessly from PTU 102, and may be further configured to charge battery 154, as described herein. Although each of these components is shown in the illustrated embodiment, other embodiments may include additional or fewer components. In other embodiments, PRU 144 may include components necessary to receive and store other forms of wirelessly communicated energy, such as capacitive charging.

Each respective processor 110, 170, 148 of PTU 102 or PRUs 166 and 144 may be implemented as appropriate in hardware, software, firmware, or combinations thereof. Software or firmware implementations of processors 110, 170, and 148 may include computer-executable or machine-executable instructions written in any suitable programming language to perform the various functions described. Hardware implementations of processors 110, 170, 148 may be configured to execute computer-executable or machine-executable instructions to perform the various functions described. Processors 110, 170, 148 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. PTU 102 and/or PRUs 166, and/or 144 may also include a chipset (not shown) for controlling communications between one or more processors 110, 170, 148 and one or more of the other components of PTU 102 or PRUs 166 and 144. Processors 110, 170, 148 may also include one or more application specific integrated circuits (ASICs) or application specific standard products (ASSPs) for handling specific data processing functions or tasks. In certain example embodiments, PTU 102 and/or PRUs 166 and 144 may be based on an Intel® Architecture system and the processors 110, 170, 148 and chipset may be from a family of Intel® processors and chipsets, such as the Intel® Atom® processor family.

I/O Interface(s) 114, 172, 150 included in PTU 102 and PRUs 166 and 144 may enable the use of one or more user interfaces for receiving user input and/or providing output to the user. A user may be able to administer or manage the systems and methods disclosed herein by interacting with PTU 102 or PRUs 166 and 144 via I/O Interfaces 114, 172, 150, such as a touchscreen interface, a display, a guided user interface, or any other input/output interface. I/O interfaces 114, 172, 150 may be in the form of a touch screen, microphone, accelerometer sensor, speaker, or any other suitable I/O Interfaces 114, 172, 150 that may be used by the user to interact with the PTU 102 or PRUs 166, 144.

Memory 116 of PTU 102, as well as memory 178 and 156 of PRU 166 and second PRU 144, respectively, may include one or more volatile and/or non-volatile memory devices including, but not limited to, magnetic storage devices, read only memory (ROM), random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof.

Memory 116 of PTU 102, as well as the memory 178 and 156 of PRU 166 and second PRU 144, respectively, may store program instructions that are loadable and executable on each respective processor 110, 170, 148, as well as data generated or received during the execution of these programs. Each memory 116, 178, and 156 may include several modules. Each of the modules and/or software may provide functionality for PTU 102 or PRUs 166, 144, when executed by the processors 110, 170, and 148. The modules and/or the software may or may not correspond to physical locations and/or addresses in each memory 116, 178, and 156. In other words, the contents of each of the modules may not be segregated from each other and may, in fact be stored in at least partially interleaved positions on each memory 116, 178, 156.

Memory 116, 178, and 156 of PTU 102, PRU 166 and PRU 144 may include operating systems 126, 184, and 162. Processors 110, 170, and 148 of PTU 102 or corresponding PRUs 166 and 144 may each be configured to access and execute one or more operating systems stored in the respective operating systems 126, 184, and 162 to operate the system functions of the electronic device. System functions, as managed by the operating system may include memory management, processor resource management, driver management, application software management, system configuration, and the like. The operating system may be any variety of suitable operating systems including, but not limited to, Google® Android®, Microsoft® Windows®, Microsoft® Windows® Server®, Linux, Apple® OS-X®, or the like.

Memory 116, 178, and 156 of PTU 102, PRU 166, and PRU 144 may include a communication module 124, 182, and 160 respectively. Each communication module 124, 182, and 160 may contain instructions and/or applications thereon that may be executed by each respective processor 110, 170, 148 to provide one or more functionality associated with the directional distribution and reception of wireless signals and task processing. These instructions and/or applications may, in certain aspects, interact with each respective operating system 126, 184, 162 and/or other modules of PTU 102 and/or PRUs 166 and 144. Each communication module 124, 182, and 160 may have instructions, software, and/or code stored thereon that may be launched and/or executed by the processors 110, 170, and 148 to execute one or more applications and functionality associated therewith. These applications may include, but are not limited to, functionality such as web browsing, business, communications, graphics, word processing, publishing, spreadsheets, databases, gaming, education, entertainment, media, project planning, engineering, drawing, or combinations thereof.

Radios 112, 174, and 152 of PTU 102 and/or PRUs 166 and 144 may be a transmit/receive component, such as a transceiver. Radios 112, 174, and 152 may include any suitable radio(s) and/or transceiver(s) for transmitting and/or receiving radio frequency (RF) signals in the bandwidth and/or channels corresponding to the communications protocols utilized by PRUs 166 and 144 to communicate with each other or with other user devices and/or PTU 102 or another component of PTU 102. Radios 112, 174, and 152 may include hardware and/or software to modulate communications signals according to pre-established distribution protocols. Radios 112, 174, and 152 may further have hardware and/or software instructions to communicate via one or more Wi-Fi and/or Wi-Fi direct protocols, as standardized by the Institute of Electrical and Electronics Engineers (IEEE) 802.11 standards. In certain embodiments, radios 112, 174, 152, in cooperation with their respective antennas 128, 168, and 146 may be configured to communicate via 2.4 GHz channels (e.g., 802.11b, 802.11g, 802.11n), 5 GHz channels (e.g., 802.11n, 802.11ac), or 60 GHZ channels (e.g., 802.11ad). In alternative embodiments, non-Wi-Fi protocols may be used for communications between PTU 102 and/or PRUs 166 and 144, such as BLUETOOTH™, BLUETOOTH™ LE, Near Field Communication, dedicated short-range communication (DSRC), or other packetized radio communications. Radios 112, 174, and 152 may include any known receiver and baseband suitable for communicating via the communications protocols of PTU 102 and/or PRUs 166 and 144. Radios 112, 174 and 152 may further include a low noise amplifier (LNA), additional signal amplifiers, an analog-to-digital (A/D) converter, one or more buffers, and digital baseband.

Antenna 128, 168, and 146 included in PTU 102 and respective PRUs 166 and 144 may be configured for receiving and/or transmitting communications signals from/to each other or other components of PTU 102. Antennas 128, 168, and 146 may be any suitable type of antenna corresponding to the communications protocols used by PTU 102 and/or PRUs 166, and 144 for the particular signals received and/or transmitted via antennas 128, 168, and 146. Some non-limiting examples of suitable antennas 128, 168, and 146 may include directional antennas, non-directional antennas, dipole antennas, folded dipole antennas, patch antennas, multiple-input multiple-output (MIMO) antennas, or the like. Each antenna 128, 168, and 146 may be communicatively coupled to a radio component to transmit and/or receive signals, such as communications signals to and/or from PTU 102 and/or the PRUs 166 and 144.

Antennas 128, 168, and 146 may be configured to receive and/or transmit signals in accordance with established standards and protocols, such as Institute of Electrical and Electronics Engineers (IEEE) 802.11 family of standards, including via 2.4 GHz channels (e.g., 802.11b, 802.11g, 802.11n), 5 GHz channels (e.g., 802.11n, 802.11ac), or 60 GHZ channels (e.g., 802.11ad). In alternative example embodiments, antennas 128, 168, and 146 may be configured to receive and/or transmit non-Wi-Fi protocol signals, such as BLUETOOTH™, BLUETOOTH™ LE, Near Field Communication, dedicated short-range communication (DSRC), or other packetized radio communications.

PRUs 166 and 144, as well as PTU 102, may include an energy storage device, such as battery 140, 176, and 154. Each battery 140, 176, and 154 may be configured to provide energy or otherwise power to each respective PRU 166 and 144. Batteries 140, 176, and 154 may be any suitable type of battery including, but not limited to, wet cells, dry cells, lead-acid, lithium, lithium hydride, lithium ion, or the like, at any suitable voltage and/or output current. In certain embodiments, the batteries 140, 176, and 154 may be rechargeable and may be recharged by one or more other power sources, such as PTU 102. Each battery 140, 176, and 154 may be configured to receive and store energy.

PTU 102 and each PRU 166 and 144 may include a respective resonator 132, 186, and 164. Each resonator 132, 186 and 164 may be any suitable resonator configured to provide, distribute, transmit, or receive energy. For example, resonator 132 may be configured to transmit, emit, or otherwise transfer energy wirelessly, and resonators 186 and 164 may be configured to receive energy transmitted by resonator 132. Resonators 132, 186, and 164 may be electromagnetic resonators in one example. Resonators 186 and 164 may be electrically coupled to each respective battery 176 and 154 of PRUs 166 and 144, and may be configured to charge, recharge, and/or provide energy to batteries 176 and 154. Other wireless charging technologies, including infrared (IR), capacitive, or other technologies may be incorporated into PTU 102.

PTU 102 may include power module 134 and power supply 136. Power module 134 and power supply 136 may be electrically coupled to resonator 132, and may energize resonator 132 such that resonator 132 may wirelessly transfer power. Power supply 136 may be a battery, for example battery 140, and/or may be a connection to external power source 138. Power supply 136 may further include AC/DC power conversion capabilities and/or converters. External power source 138 may be power provided from a power outlet 142, as shown. The connection between PTU 102 and external power supply 138 may be a standard wall outlet, a Universal Serial Bus connection, a FIREWIRE™ or LIGHTNING™ connection, or any other connection configured to deliver power to PTU 102. In some embodiments, power supply 136 may be an intermediary between PTU 102 and external power supply 138. Power module 134 may amplify energy from power supply 136 to ensure resonator 132 has sufficient energy to wirelessly transmit or distribute energy. For example, power module 134 may provide current to resonator 132, which may comprise one or more micro-PTU-coils capable of generating a magnetic field that may in turn generate a magnetic flux in one or more coils in a device, thereby inducing an electromotive force (i.e., voltage) and corresponding current in the device. Power Module 134 may comprise a charging module (not shown in FIG. 1), such as charging module 302e, and a scanning module (not shown in FIG. 1), such as scanning module 302f.

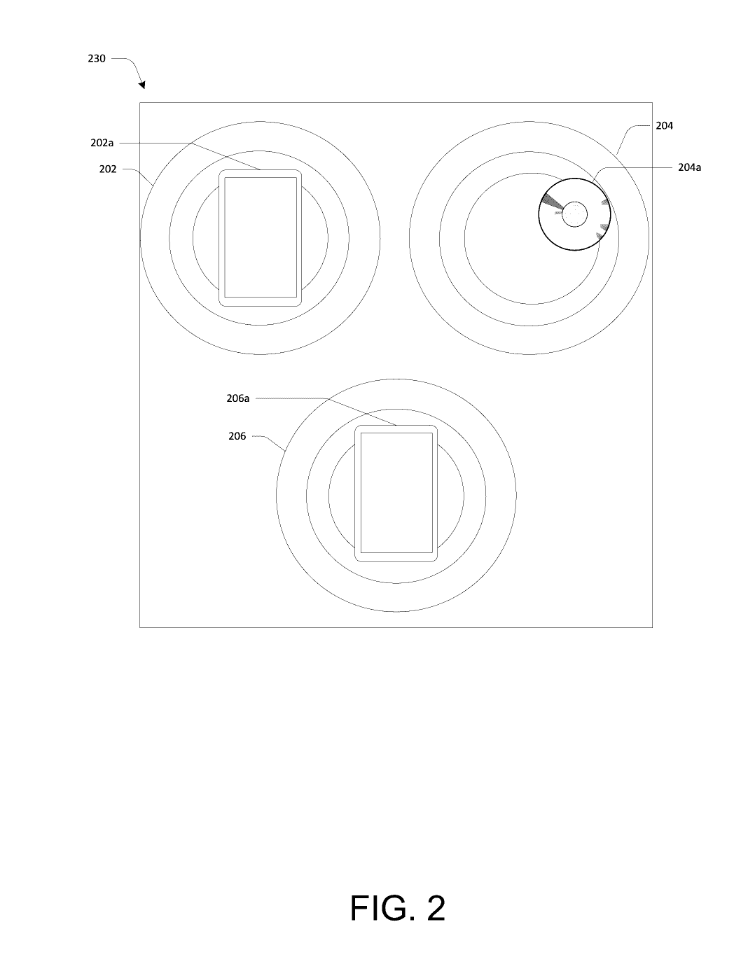

FIG. 2 is an illustrative diagram of an example charge area 230 of a wireless charging device, that is, a PTU (e.g., PTU 102), in accordance with example embodiments of the disclosure. The charging area 230 comprises, among other things not depicted in FIG. 2, four non-overlapping coils, for example, micro-PTU-coils 202, 204, and 206. The non-overlapping micro-PTU-coils may have a specific geometry different from the geometry illustrated in FIG. 2. In some embodiments, a subset of the non-overlapping micro-PTU-coils in charging area 230 may have a different geometry than the other non-overlapping micro-PTU-coils in the PTU. For example, if the shape and size of charging area 230 is limited to certain dimensions, the shape of the micro-PTU-coils may differ in size and geometry to maximize the number of micro-PTU-coils that may be provided by the PTU 200. The geometry of the micro-PTU-coils may also be based on the type of PRUs that can be charged on PTU 200. For example, the geometry of non-overlapping micro-PTU-coils 206 and 202 may be a circle, but the geometry of non-overlapping micro-PTU-coils 204 may be rectangular.

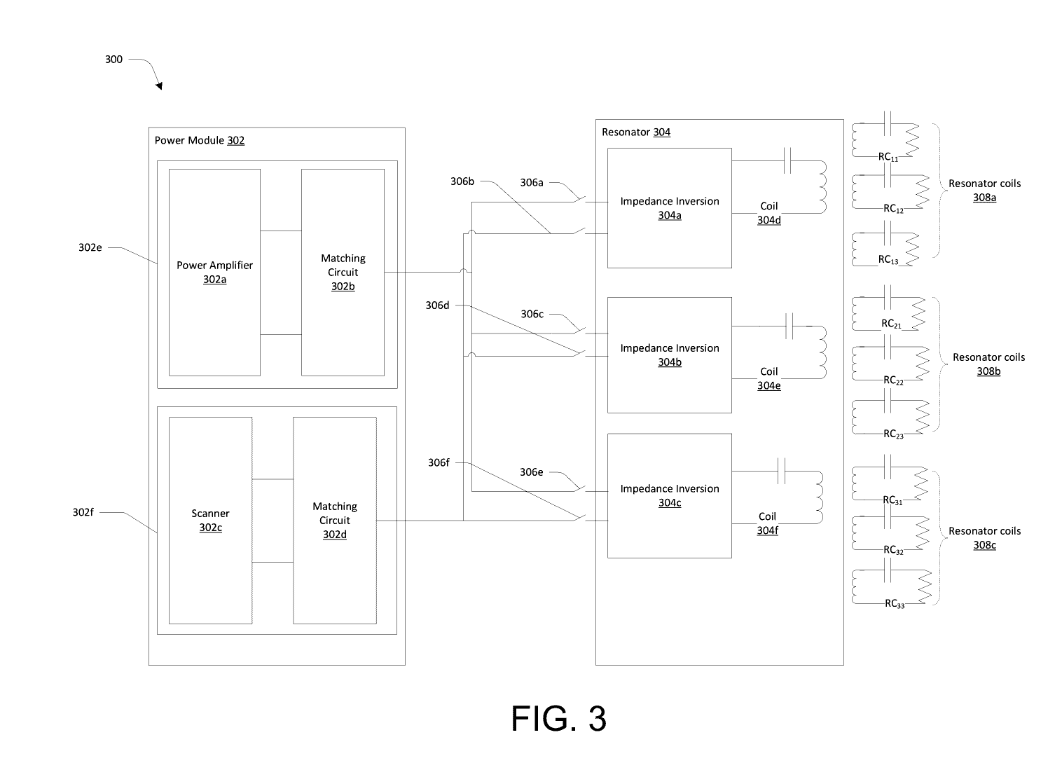

If a non-overlapping micro-PTU-coils 204 has object 204a positioned over or partially over it, then the non-overlapping micro-PTU-coils 204 may detect object 204a using systems and methods disclosed herein. Object 204a may be a properly implemented wireless charging enabled device or it may be an interfering object (e.g., a Compact Disc (CD) or Digital Video Disc (DVD)). Non-overlapping micro-PTU-coils 204 may be connected to an impedance inversion circuit (e.g., Impedance Inversion 304a) which may receive one or more periodic voltage waveforms (e.g., group short beacons and/or group long beacons) from Power Module 134. The group short beacons and group long beacons, may also be referred to as group short beacon signals and group long beacon signals. The impedance inversion circuit (e.g., Impedance Inversion 304a) may convert the periodic voltage waveforms supplied by Power Module 134 to periodic current waveforms routed to non-overlapping micro-PTU-coils 204, which may correspond to Micro-PTU-coils 304d in FIG. 3. Micro-PTU-coils 202 and 206 may correspond to Micro-PTU-coils 304e and 304f respectively. As explained below, Power Module 134 may comprise a charging module (e.g., charging module 302e) and a scanning module (e.g., scanning module 302f [not seeing this in the drawings]). Non-overlapping micro-PTU-coils 204 may receive the one or more periodic current waveforms from scanning module 302f, and if PTU 200 determines that object 204a is an interfering object (e.g., a DVD), PTU 200 may instruct scanning module 302f to continue to send periodic wireless waveforms. If this occurs, non-overlapping micro-PTU-coils 204 may be said to be in a latching-fault state (e.g., Latching Fault State 418). If object 204a is a PRU, PTU 200 may instruct charging module 302e to provide power to non-overlapping micro-PTU-coils 204.

PTU 200 may determine if object 204a is an interfering object by initiating a group short beacon, and detecting a variation in the load experienced by one or more impedance inversions (e.g., impedance inversion 304a, 304b, and/or 304c) due to the proximity of object 204a. The group short beacon (e.g., group short beacon sequence 502a, 504a, 506a . . . M) may comprise one or more voltage waveforms, generated by scanner 302c and applied to one or more impedance inversions (e.g., impedance inversion 304a, 304b, and/or 304c). The one or more impedance inversions may convert the voltage waveform to a current waveform and apply it to the one or more micro-PTU-coils (e.g., micro-PTU-coils 304d, 304e, and/or 304f) on/in PTU 200, which in turn may generate a magnetic field in the one or more micro-PTU-coils. If object 204a is proximate to one or more micro-PTU-coils that may be used to wirelessly charge a PRU, and a PRU, with one or more coils, is brought within a proximate distance of non-overlapping micro-PTU-coils 204, PTU 200 may detect a change in the impedance inversion circuits. When the group short beacon is received by the impedance inversion circuits, the impedance inversion circuits may apply a first current to non-overlapping micro-PTU-coils 204, which in turn may generate a first time varying magnetic field. The first time varying magnetic field may be time varying with respect to each current waveform and may have the same periodicity as the cycle of one of the current waveforms in the group short beacon (e.g., t_{CYCLE} 503). The first time varying magnetic field in turn may generate a first magnetic flux in the coils of the wireless chargeable mobile device, that is, a PRU. The first magnetic flux in the coils of the PRU may in turn generate a first electromotive force (EMF) in the coils of the PRU. The first EMF may induce a current in the coils of the PRU, which may in turn generate a second magnetic field. The second magnetic field may induce a second magnetic flux in non-overlapping micro-PTU-coils 204. The second magnetic flux may in turn generate a second EMF in non-overlapping micro-PTU-coils 204. The second EMF may generate a second current in non-overlapping micro-PTU-coils 204. The second current in non-overlapping micro-PTU-coils 204 may change the impedance of non-overlapping micro-PTU-coils 204, and may be detected by the impedance inversions. The impedance of non-overlapping micro-PTU-coils 204 may have a first impedance, when the first current is applied to non-overlapping micro-PTU-coils 204. The impedance of non-overlapping micro-PTU-coils 204 may have a second impedance, when the second current is induced in non-overlapping micro-PTU-coils 204 in response to the second EMF. The impedance may be a measure of the reactance and resistance of non-overlapping micro-PTU-coils 204. In particular, the impedance inversion circuit may detect a change in the reactance of a capacitive and/or inductive element of non-overlapping micro-PTU-coils 204 (e.g., Micro-PTU-coils 304d). The impedance inversion may detect a change in the resistance of non-overlapping micro-PTU-coils 204. If the change in impedance does not correspond to a predetermined change, PTU 200 may determine that an interfering object (i.e., object 204a may be a DVD) is proximate to non-overlapping micro-PTU-coils 204. The change in impedance may not correspond to a predetermined change because object 204a may interfere with the second magnetic field and hence second magnetic flux generated by the device. The predetermined change in impedance may correspond to the impedance exceeding a predetermined threshold. The threshold may be a function of the sensitivity of non-overlapping micro-PTU-coils 204, and may be adjusted depending on the types of PRUs a user may want to charge and/or may not want to charge. PTU 200 may place non-overlapping micro-PTU-coils 204 in a latching fault state, if the change impedance does not correspond to a predetermined change. PTU 200 may display a latching fault message on a display (not shown) of charge area 130 indicating that an interfering object (e.g., object 204a) is on non-overlapping micro-PTU-coils 204 and must be removed before charging of the PRU may begin. Alternatively, a message may be sent to the PRU wirelessly indicating the same thing. After the interfering object is removed PTU 200 may instruct charging module 302e to provide power to non-overlapping micro-PTU-coils 204 which will in turn generate an EMF and provide current to the device as explained above.

While the interfering object in this example embodiment is the object 204a (e.g., a DVD) it is understood that an interfering object is an object that is not a chargeable PRU, but one that will not energize micro-PTU-coils 204, and in doing so occupies a space on charging area 230 that cannot be used to charge a PRU. If object 204a (e.g., a DVD) is detected on micro-PTU-coils 204 while the micro-PTU-coils 204 is energized, that is, receiving power from a resonator of the PTU 200, then the PTU 200 will de-energize micro-PTU-coils 204. For example, a wirelessly chargeable PRU may be charging on micro-PTU-coils 204 after the device finishes charging it may be removed from micro-PTU-coils 204. If the object 204a (e.g., a DVD) is placed over the micro-PTU-coils 204 before non-overlapping micro-PTU-coils 204 de-energizes non-overlapping micro-PTU-coils 204, then the PTU 200 may detect that object 204a is not a wirelessly chargeable PRU and may de-energize micro-PTU-coils 204. Mobile phones 202a and 206a may be PRUs that charged by micro-PTU-coils 202 and 206 respectively. When mobile phones 202a and 206a are placed on micro-PTU-coils 202 and 206, respectively, PTU 200 may detect mobile phones 202a and 206a, and then energize micro-PTU-coils 202 and 206 to begin charging mobile phones 202a and 206a. Mobile phones 202a and 206a may comprise one or more of the components of PTUs 166 and 144 respectively. That is mobile phone 202a my comprise a processor (i.e., Processor(s) 170), an input/output interface (i.e., I/O Interface(s) 172), a radio (i.e., Radio 174), a memory (i.e., Memory 178), a battery (i.e., Battery 176), a resonator (i.e., Resonator 186), parameter data associated with mobile phone 202a (i.e., Parameter Data 180), communication data associated with mobile phone 202a (i.e., Communication Module 182), an operating system (i.e., Operating System 184), and an antenna (i.e., Antenna 168). And mobile phone 206a may comprise a processor (i.e., Processor(s) 148), an input/output interface (i.e., I/O Interface(s) 150), a radio (i.e., Radio 152), a memory (i.e., Memory 156), a battery (i.e., Battery 154), a resonator (i.e., Resonator 164), parameter data associated with mobile phone 206a (i.e., Parameter Data 158), communication data associated with mobile phone 206a (i.e., Communication Module 160), an operating system (i.e., Operating System 162), and an antenna (i.e., Antenna 146).

FI G. 3 is an illustrative schematic diagram of an example PTU 300, in accordance with example embodiments of the disclosure. PTU 300 may be comprised of at least one power module (power module 302) and at least one resonator (resonator 304). Power module 302 may comprise some or all of the components of Power Module 134. Power module 302 may be comprised of at least one charging module 302e and scanning module 302f. Charging module 302e may be comprised of at least one power amplifier (power amplifier 302a) and at least one matching circuit (matching circuit 302b). Scanning module 302f may be comprised of at least one power amplifier (scanner 302c) and at least one matching circuit (matching circuit 302d). Power amplifier 302a may be connected to matching circuit 302b, and scanner 302c may be connected to matching circuit 302d. Resonator Coils 308a, 308b, and/or 308c may be one or more coils in one or more PRUs. They may comprise one or more circuit elements including, but not limited to resistors, capacitors, and/or inductors. Resonator Coils 308a, 308b, and/or 308c may include one or more resistors, capacitors, and/or inductors. The ratings of the one or more circuit elements may be depend on a temperature protection condition such that the PRU does not exceed a predetermined value when the PRU is charging. The ratings may also be dependent on a current protection condition such that the PRU does not consume more current than a predetermined value when the PRU is charging. The ratings may also depend on a voltage protection condition such that the PRU does not consume more voltage than a predetermined value when the PRU is charging.

Power amplifier 302a may output a DC and/or AC voltage to matching circuit 302b, which may provide a constant or time varying current and voltage to resonator modules 304 through switch 306a. The voltage output by power amplifier 302a may provide power to micro-PTU-coils 304d, 304e, and 304f. Power amplifier 302a may provide voltage and/or current to micro-PTU-coils 304d, 304e, and 304f such that the voltage and/or current provided to micro-PTU-coils 304d, 304e, and 304f may induce a magnetic flux matching the power requirements of one or more PRUs.

Power amplifier 302a may be comprised of switching devices (e.g., MOSFET transistors, GaN transistors), oscillators, gate drivers, logic gates, resistors, inductors, capacitors, diodes etc. Power amplifier 302a may convert a DC voltage to an AC signal. In combination with matching circuit 302b, power amplifier 302a is designed to supply a mostly constant AC voltage (Vtx) over a relatively wide range of load conditions for a given DC supply voltage, provided by a power supply (e.g., power supply 136). Matching circuit 302b may be comprised of inductors and capacitors and may convert the output of power amplifier 302a to a constant voltage AC signal (Vtx).

Scanner 302c may detect the location of a PRU relative to micro-PTU-coils 304d, 304e, and 304f by sending beacons (electrical signals through matching circuit 302d and switches 306b, 306d, and/or 306f) to impedance inversion 304a, 304b, and/or 304c. Impedance inversions 304a, 304b, and/or 304c may detect a change in the reactance and/or resistance of micro-PTU-coils 304d, 304e, and 304f, in response to the beacons as explained above in the example of mobile phone 204a. A change in reactance and/or resistance of micro-PTU-coils 304d, 304e, and/or 304f may indicate that a PRU has been placed adjacent at least one of the micro-PTU-coils 304d, 304e, 304f.

Scanner 302c may be comprised of switching devices (e.g., MOSFET transistors, GaN transistors), oscillators, gate drivers, logic gates, resistors, inductors, capacitors, diodes etc. Scanner 302c may convert fixed or time varying DC voltage waveform supplied to it to a modulated AC voltage and/or current waveform. For example, scanner 302c may use one or more of switching devices, oscillators, gate drivers, logic gates, resistors, inductors, capacitors, and/or diodes to modulate the amplitude of the supplied DC voltage waveform to create an AC voltage and/or current waveform corresponding to a short and/or periodic long beacon. In combination with matching circuit 302d, the scanner 302c is designed to supply a mostly constant AC voltage (Vtx) over a relatively wide range of load conditions for a given DC supply voltage, provided by a power supply (e.g., power supply 136). Matching circuit 302d may be comprised of inductors and capacitors that may be used to convert the output of scanner 302c to a constant AC voltage waveform. Scanner module 302f may be configured to supply short beacons and/or periodic long beacons in the form of a modulated AC voltage waveform, which may be routed to resonator 304 through switches 306b, 306d and 306f.

In some embodiments, power amplifier 302a may perform the same functions as scanner 302c described above. For example, if scanner 302c is damaged, or non-responsive, power amplifier 302a may provide power to resonator modules 304 and send beacons instructing resonator modules 304 to check for a change in reactance or resistance in micro-PTU-coils 304d, 304e, and/or 304f. In other embodiments, both power amplifier 302a and scanner 302c may provide power to resonator modules to charge PRUs. For example, power amplifier 302a may execute the same functions as scanner 302c, and scanner 302c may execute the same functions as power amplifier 302a.

Resonator module 304 may be comprised of at least one impedance inversion circuit (impedance inversion circuits 304a, 304b, and 304c) coupled to at least one micro-PTU-coil (micro-PTU-coils 304d, 304e, and 304f), wherein impedance inversions 304a, 304b, and 304c may be coupled to micro-PTU-coils 304d, 304e, and 304f, respectively. Impedance inversion circuits 304a, 304b, and 304c may be circuits that convert the constant voltage produced by matching circuit 302b to a constant current that is inputted to micro-PTU-coils 304d, 304e, and 304f. The phase shift and impedance transformation may be based on, among other things, a requirement communicated by a device to maintain the power it is to receive within a threshold that does not exceed or drop below a certain level. The phase shift and impedance transformation may also be based on a requirement that the frequency and phase of the power received by the one or more PRUs is synchronized with the power produced by power amplifier 302a. Impedance inversion circuits 304a, 304b, and 304c may be connected to matching circuit 302b in several ways. In some embodiments, impedance inversions 304a, 304b, and 304c may be connected to matching circuit 302b in a tiling architecture. The tiling architecture may be an architecture in which each of the impedance inversion circuits 304a, 304b, and 304c are connected in parallel to matching circuit 302b. The tiling architecture may enable PTU 300 to selectively energize micro-PTU-coils 304d, 304e, and 304f independently without disabling all of them. Processor(s) 110 may open and close switches 306a, 306c, and 306e in order to selectively energize micro-PTU-coils 304d, 304e, and 304f. In other embodiments, impedance inversion circuits 304a, 304b, and 304c may be connected in series with matching circuit 302b, and micro-PTU-coils 304d, 304e, and 304f may be disabled if one of the micro-PTU-coils is disabled. Switches 306a, 306c, and 306e may connect matching circuit 302b to impedance inversions 304a, 304b, and 304c. Switches 306b, 306d, and 306f may connect matching circuit 302d to impedance inversions 304a, 304b, and 304c. Switches 306a, 306c, and 306e may connect charging module 302e to impedance inversion circuits 304a, 304b, and 304c when one or more PRUs are detected by one or more impedance inversions 304a, 304b, and 304c and corresponding micro-PTU-coils 304d, 304e, and 304f. Switches 306a, 306c, and 306e may be controlled by processor(s) 110 to provide power to one or more impedance inversion circuits 304a, 304b, and 304c and corresponding micro-PTU-coils 304d, 304e, and 304f.

Switches 306a-306f may be comprised of one or more mechanical relays, solid state switches comprised of semiconductor devices, such as diodes, MOSFETs, BJTs, GaN transistors, PIN diodes etc.

For example, in some embodiments scanner module 302f may close or open one or more of switches 306b, 306d, and 306f based on input from scanner 302c. In particular, scanner 302c may send a periodic group short beacon to resonator module 304 to determine if a change in reactance and/or resistance of micro-PTU-coils 304d, 304e, and/or 304f may have been detected by impedance inversions 304a, 304b, and/or 304c. The periodic group short beacon may be a group of current waveforms as explained above. The current waveforms may have a predetermined period and amplitude. Matching circuit 302d may open and close switches 306b, 306d, and 306f to enable scanner 302c to send the periodic group short beacons to micro-PTU-coils 304d, 304e, and 304f in order to detect if one or more PRUs are proximate to micro-PTU-coils 304d, 304e, and 304f If a change in reactance and/or resistance is detected at micro-PTU-coils 304d, 304e, and/or 304f by impedance inversions 304a, 304b, and/or 304c during the periodic group short beacon, PTU 300 may determine if the change in reactance and/or resistance exceeds a predetermined threshold. The change in reactance and/or resistance may be due to one or more of resonator coils 308a. 308b, and/or 308c being in proximate to micro-PTU-coils 304d, 304e, and/or 304f. Resonator coils 308a, 308b, and/or 308c may correspond to the coils in three different PRUs.

If the reactance and/or resistance exceed the predetermined threshold, PTU 300 may determine that the change is due to an interfering object. As a result, PTU may place one or more of micro-PTU-coils 304d, 304e, and/or 304f in a latching fault state (i.e., continue sending group short beacons until the interfering object is removed as explained above). If PTU 300 determines the change is due to a non-interfering object (i.e., a PRU), matching circuit 302d may send one or more periodic long beacons to determine which micro-PTU-coil(s) voltage and/or current should be sent in order to provide power to the PRU. The periodic long beacons may be current waveforms that last a predetermined period, and may have predetermined amplitude. The predetermined period and amplitude of the periodic long beacons may be greater than the predetermined period and amplitude of the current waveforms in the group short beacon.

After PTU 300 sends one or more periodic long beacons, PTU 300 may receive a message, from the one or more PRUs over a wireless radio link, requesting PTU 300 to provide voltage and/or current to one or more micro-PTU-coils proximate to the one or more PRUs. The one or more PRUs may select a micro-PTU-coil based on the coupling strength between the PRUs and one or more micro-PTU-coils 304d, 304e, and/or 304f. For example, resonator coil RC₂₃ may receive a periodic long beacon from micro-PTU-coils 304e and 304f, but may determine that the magnetic coupling strength (magnetic flux induced by the periodic long beacon current waveform) between RC₂₃ and micro-PTU-coil 304e is greater than the magnetic coupling strength between RC₂₃ and micro-PTU-coil 304f. PTU 300 may receive a message from the PRU with resonator coil RC₂₃ in and/or on it, requesting that voltage and/or current be sent to micro-PTU-coil 304e. The wireless radio link may be created using a Bluetooth Low Energy protocol, between a radio on PTU 300 (e.g., radio 112) and a radio on the one or more PRUs (e.g., radios 174 and 152). After receipt of the message, matching circuit 302d may open switches 306b, 306d, and/or 306f to stop periodic group short beacons and periodic long beacons from being sent to micro-PTU-coils 304d, 304e, and 304f. Matching circuit 302b may close one or more of switches 306a, 306c, and/or 306e depending on the one or more micro-PTU-coils a PRU has requested voltage and/or current be sent to. The voltage and/or current provided to micro-PTU-coil 304e may induce a magnetic flux in one or more of resonator coils 308b such that the voltage and current induced in the one or more resonator coils 308b, in and/or on the corresponding PRUs, is sufficient to charge the PRUs.

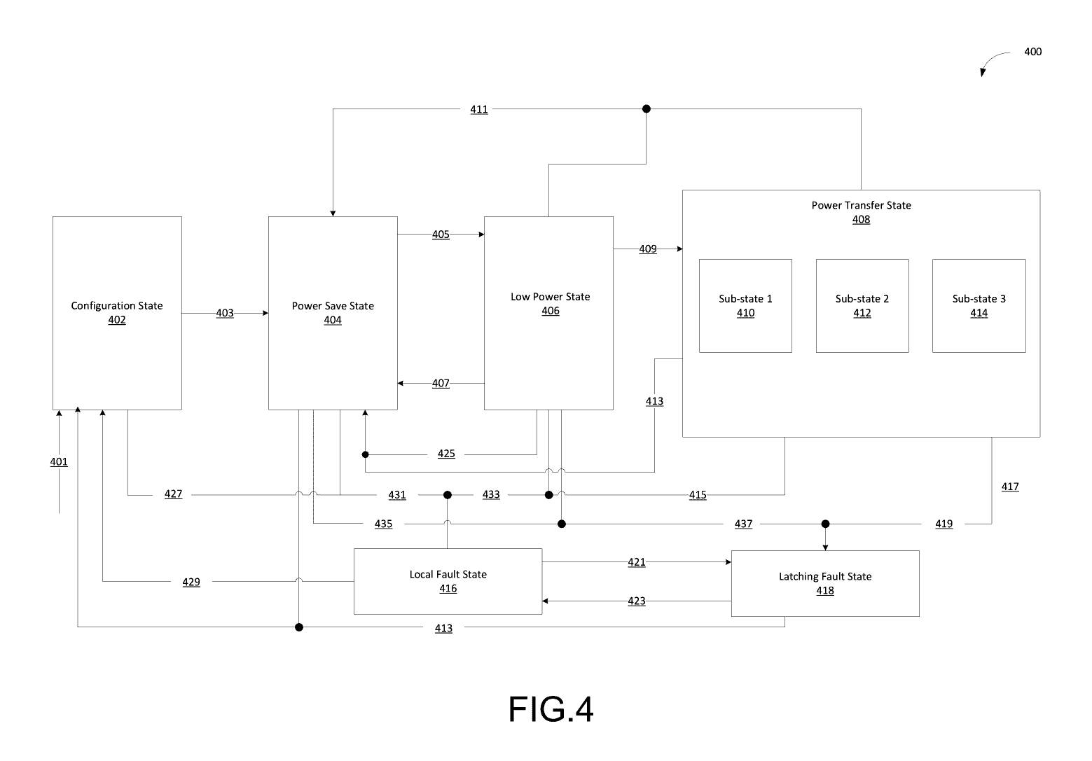

When a user turns on a PTU in accordance with the disclosure, such as PTU 102, that device may perform one or more actions in the illustrative state transition diagram 400 in FIG. 4. Initially the PTU may be turned on at 401. The PTU may be turned on by a switch on the PTU in some embodiments, and may be turned on remotely via a radio (i.e., Radio 112) in other embodiments. After the PTU is turned on at 401, the PTU may configure itself in Configuration State 402. The PTU may perform self and system checks during Configuration State 402. The self and system checks may include, but are not limited to, checking one or more of the components within the PTU and/or actuating a power supply (i.e., Power Supply 136) to deliver a predetermined current to a power module (i.e., Power Module 134) to route the predetermined current to one or more micro-PTU-coils (e.g., micro-PTU-coils 304d-f). The predetermined current may be less than a threshold (e.g., 50 milliamperes root mean square). If the current is above the threshold, the PTU may adjust the current so that it is below the threshold. The self and system checks may include checking the functionality of Resonator 132, Power Module 134, Power Supply 136, Memory 116, Radio 112, I/O Interface(s) 114, battery 140, and/or Charge Area 130. After configuration is complete in 402, the PTU may enter Power Save State 404 through 403. When the PTU is in power save state 404, the PTU may start a short group beacon sequence within 50 milliseconds of entering power save state 404. PTU 300 may also clear its memory (i.e., Memory 116) of data associated with wirelessly chargeable PRUs previously charged by the PTU. While the PTU is in power save state 404, a scanning module (i.e., scanner 302c and matching circuit 302d) may send group short beacons, as explained above and below, to micro-PTU-coils 304d, 304e, and 304f to detect changes in impedance in response to one or more PRUs proximate to micro-PTU-coils 304d, 304e, and 304f.

If a load is detected, scanner 302c may send one or more periodic long beacons to micro-PTU-coils 304d, 304e, and/or 304f to determine the micro-PTU-coil(s) providing the strongest magnetic coupling to the one or more PRUs as explained above.

PTU 300 may enter low power state 406 after the periodic long beacon is sent. The one or more PRUs may determine which micro-PTU-coil(s) provide the strongest magnetic coupling and may send an advertisement to PTU 300 indicating which micro-PTU-coils PTU 300 should energize. The message may establish a communication link between PTU 300 and the one or more devices may be sent using a Bluetooth Low Energy protocol. After PTU 300 receives the message power amplifier 302a may apply a current and/or voltage to one or more of the micro-PTU-coil(s) 304d, 304e, and/or 304f indicated in the message in power transfer state 408.

The group short beacon sequence may be used by PTU 300 to detect changes in impedance in impedance inversion 304a, 304b, and 304c. The periodic long beacon sequence may be used by PTU 300 to determine if a wirelessly chargeable PRU has sufficient power to boot up and respond to beacons received from PTU 300. In some embodiments, and as discussed below, the periodic long beacon sequence may also be used to determine the best micro-PTU-coils (e.g., micro-PTU-coil(s) 304d, 304e, and/or 304f) to provide power to properly power the wirelessly chargeable PRU.

The group short beacon sequence may comprise one or more waveforms that last a predetermined length of time. The group short beacon sequence may be comprised of one or more on periods, in which scanner 302c scans impedance inversion 304a, 304b, and/or 304c to detect a change in reactance and/or impedance at micro-PTU-coils 304d, 304e, and 304f Each of the one or more on periods may be less than 30 milliseconds. The one or more on periods may be the same length of time, or they may be different lengths of time. For example, a first subset of the one or more on periods may have a length of 15 milliseconds, a second subset of the one or more on periods may have a length of 1 millisecond, a third subset of the one or more on periods may have a length of 17 milliseconds etc. The one or more current waveforms may have a predetermined shape, size, and dimension. For example, in some embodiments the one or more current waveforms may be square waveforms with predetermined amplitude during the on period. In other embodiments, the waveforms may not be the same. For example, a staircase waveform may be applied to impedance inversion 304a and 304b, and a square waveform may be applied to impedance inversion 304c.

The one or more on periods may be consecutive, and may be followed by an off period that is greater than the one or more on periods. For example, the one or more off periods may be a multiple of the combined length of time of the one or more on periods. The one or more current waveforms corresponding to the one or more on periods may be aligned or non-aligned in time when they are applied to the one or more impedance inversion 304a, 304b, and 304c. The one or more current waveforms in the group short beacon sequence are aligned when the one or more current waveforms occur consecutively. In some embodiments, scanner 302c may align three current waveforms in time. For example, scanner 302c may start the first current waveform, 51 milliseconds after PTU 300 is turned on, and stop the first current waveform 54 milliseconds after PTU 300 is turned on. Scanner 302c may start a second current waveform, 54 milliseconds after PTU 300 is turned on, and stop the second current waveform 57 milliseconds after PTU 300 is turned on. Scanner 302c may start a third current waveform, 57 milliseconds after PTU 300 is turned on, and stop the third current waveform 60 milliseconds after PTU 300 is turned on. In other embodiments, the one or more waveforms in the group short beacon may be non-aligned. The one or more current waveforms are non-aligned if there is a gap in time between the one or more current waveforms. Referring to the example above, if the three current waveforms are not consecutive, there may be a gap in time (e.g., 2 milliseconds) between the first, second, and third current waveforms. If the one or more current waveforms are non-aligned in time, the order in which scanner 302c applies the one or more current waveforms to impedance inversion 304a, 304b, and 304c may be in serial or parallel. For instance, scanner 302c may send a group short beacon comprising three current waveforms to each impedance inversion 304a, 304b, and 304c, and there may be a gap in time between when each current waveform ends and when each of the other current waveforms begin. As an example, a first current waveform may be applied to impedance inversion 304a during an on period of 51 milliseconds to 54 milliseconds. A second current waveform may be applied to impedance inversion 304a during an on period of 57 milliseconds to 60 milliseconds. A third current waveform may be applied to impedance inversion 304a during an on period of 63 milliseconds to 66 milliseconds. Scanner 302c may also apply a first current waveform to impedance inversion 304b during an on period of 52 milliseconds to 53 milliseconds, and a first current waveform to impedance inversion 304c during an on period of 53 milliseconds to 54 milliseconds. Scanner 302c may apply a second current waveform to impedance inversion 304b during an on period of 58 milliseconds to 59 milliseconds, and a second current waveform to impedance inversion 304c during an on period of 59 milliseconds to 60 milliseconds. Scanner 302c may apply a third current waveform to impedance inversion 304b during an on period of 64 milliseconds to 65 milliseconds, and a third current waveform to impedance inversion 304c during an on period of 65 milliseconds to 66 milliseconds. In this example, the first, second and third current waveforms applied to impedance inversion 304b and 304c overlap in time with the first, second, and third current waveforms applied to impedance inversion 304a, and are therefore parallel in order. In particular, the first current waveform applied to impedance inversion 304a may occur during the on period of 51 milliseconds to 54 milliseconds, and the first current waveforms applied to impedance inversion 304b and 304c may occur during the on period of 52 milliseconds to 53 milliseconds and 53 milliseconds to 54 milliseconds respectively. Because the on periods of the first current waveforms applied to impedance inversion 304b and 304c overlap with the on period of the first current waveform applied to impedance inversion 304a, the first current waveforms applied to impedance inversion 304a, 304b, and 304c are applied in parallel. Similarly, the second and third current waveforms are applied in parallel to impedance inversion 304a, 304b, and 304c. The first, second, and third current waveforms applied to impedance inversion 304b and 304c are applied in serial, because the on period for the corresponding first, second, and third current waveforms do not overlap. For instance, the first current waveform applied to impedance inversion 304b and 304c occurs during an on period of 52 milliseconds to 53 milliseconds and 53 milliseconds to 54 milliseconds respectively. Similarly, the second and third waveforms applied to impedance inversion 304b and 304c occur during non-overlapping on periods and therefore are applied by scanner 302c in serial to impedance inversion 304b and 304c. The order in which scanner 302c applies the one or more current waveforms may be based on the scanner 302c's efficiency and/or the speed with which scanner 302c can apply the one or more current waveforms.

The long group beacon sequence may perform a finer-scanning of the micro-PTU-coils 304d, 304e and 304f received in the message from the one or more wirelessly chargeable PRUs. Scanner 302c may apply one or more current waveforms to an impedance inversion 304a corresponding to the micro-PTU-coil(s) identified in the message received from the one or more PRUs during the group short beacon sequence. Based on the reactance generated by the micro-PTU-coils identified in the message during the group long beacon sequence, PTU 300 may select all, or a subset, of the micro-PTU-coils identified in the message as the best micro-PTU-coils to couple with the one or more wirelessly chargeable PRUs. The group long beacon sequence may be similar to the group short beacon sequence. For instance, the group long beacon sequence may be comprised of one or more on periods each of which corresponds to a current waveform. However, the on period for each of the current waveforms may be greater than the on period for the current waveforms used during the group short beacon sequence. For example, in some embodiments the on period for the group long beacon sequence may be no longer than 850 milliseconds, and the group long beacon sequence may be no longer than 30 milliseconds. The amplitudes of the current waveforms used during the on period of the group long beacon sequence may be greater than, less than, or equal to the amplitudes of the current waveforms used during the on period of the group short beacon sequence. Scanner 302c may send the group short beacon sequence. The one or more current waveforms corresponding to the one or more on periods may be aligned or non-aligned in time when they are applied to the one or more impedance inversion 304a, 304b, and 304c. If the one or more current waveforms are non-aligned in time, the order in which scanner 302c applies the one or more current waveforms to impedance inversion 304a, 304b, and 304c may be in serial or parallel. The examples given above with respect to time alignment and the order in which scanner 302c applies the one or more current waveforms to impedance inversion 304a, 304b, and 304c during the group short beacon sequence, apply to the group long beacon sequence as well.

After the group short beacons and periodic long beacons have been sent, and one or more loads have been detected, the PTU may tune its radio (i.e., Radio 112) to a channel using an out-of band wireless communication protocol (e.g., Bluetooth Low Energy protocol) in 405. The PTU may tune its radio to the channel to receive advertisements (e.g., advertisement 513 and 515) from one or more PRUs (e.g., PRUs 202a and 206a) proximate to one or more micro-PTU-coils (e.g., micro-PTU-coils 202 and 206) in charge area 230. The advertisement may be received from PRUs that are not coupled to the one or more micro-PTU-coils. For example, there may be a PRU that may be brought within proximity of one or more micro-PTU-coils of the PTU that may not have been registered with the PTU.

If there are one or more PRUs that are already coupled to the one or more micro-PTU-coils then the PTU may tune its radio to receive an alert or periodic message from the one or more PRUs indicating that the one or more PRUs have not finished charging. For example, PRU 202a may send an alert using a radio (e.g., Radio 152) to the PTU's radio (i.e., Radio 112) containing a binary value equal to “0” if PRU 202a is not finished charging. PRU 206a may send an alert using a radio (e.g., Radio 174) to the PTU's radio (i.e., Radio 112) containing a binary value equal to “1” indicating that PRU 206a is finished charging. The PTU may stop sending current to micro-PTU-coil 206, which will in turn stop providing power to PRU 206a via a magnetic flux as explained above. After the advertisement and/or alert are received, the PTU may enter Low Power State 406.

After the PTU enters Low Power State 406, one or more processor(s) (i.e., Processor(s) 110) in the PTU may actuate a power supply (i.e., Power Supply 136) to deliver power to a power module (i.e., Power Module 134) that will in turn deliver current to the one or more micro-PTU-coils that the PRUs are most proximate to. Returning to the example above, Processor(s) 110 may actuate Power Supply 136 to deliver a voltage and/or current to Power Module 134, and may actuate scanner 302c and matching circuit 302d to close switches associated with the PRUs that Processor(s) 110 received advertisements and/or alerts in 405. For example, Micro-PTU-coil 304d may correspond to micro-PTU-coil 202 and Processor(s) 110 may receive an advertisement from one or more processors (e.g., Processor(s) 148) in PRU 202a. Processor(s) 110 may close switch 306b and actuate scanner 302c and matching circuit 302d to send a voltage and/or current over switch 306b to Impedance Inversion 304a which may in turn apply a current to Micro-PTU-coil 304d. This current will induce a magnetic flux in one or more coils in/on PRU 202a, which may in turn provide power to power on Radio 152 in order to enable PRU 202a to register with the PTU. PRU 202a may register with the PTU using an out-of band wireless communication protocol (e.g., Bluetooth Low Energy protocol). This process is not limited to one PRU, and may be performed in parallel with multiple PRUs. The out-of band wireless communication protocol may also be used to maintain communication between the PTU and PRUs while the PTU is charging the PRUs in Power Transfer State 408.

In some embodiments, the PRUs may have a predetermined period of time during which they must register with the PTU. If the time period expires, Processor(s) 110 may return to Power Save State 404 through 425. Processor(s) 110 may also return to Power Save State 404 through 407 if there are no PRUs detected on any of the micro-PTU-coils of the PTU. For example, if PRUs 202a and 206a were removed from micro-PTU-coils 202 and 206 respectively, and object 204a was removed from micro-PTU-coil 204, then Processor(s) 110 would reenter Power Save State 404 through 407.

After the PTU registers the one or more PRUs requesting power at one or more micro-PTU-coils of the PTU, the PRU may open one or more switches connecting a scanner and matching circuit to the one or more micro-PTU-coils. The PTU may then close one or more switches connecting a power amplifier and corresponding matching circuit to the same one or more micro-PTU-coils in Power Transfer State 408. For example, after Processor(s) 110 receives an advertisement from Processor(s) 148, PRU 202a, Processor(s) 110 may open switch 306b so that scanner 302c and matching circuit 302d no longer deliver voltage and/or current to Impedance Inversion 304a and Micro-PTU-coil 304d. Processor(s) 110 may then close switch 306a so that power amplifier 302a and matching circuit 302b deliver a voltage and/or current corresponding to the requirements to charge PRU 202a on micro-PTU-coil 202 (micro-PTU-coil 202 correspond to Micro-PTU-coil 304d in FIG. 3). There may be one or more power transfer sub-states depending on the requirements of the one or more PRUs connected to the PTU. In some embodiments, the advertisement may contain rectifier voltage information about the PRU. Processor(s) 110 may use the voltage rectifier information to determine which switch to close to electromagnetically charge the PRU. For example, a PRU may send voltage rectifier data in an advertisement specifying an output voltage of the rectifier that the PRU may maintain in order to ensure the PRU charges. For instance, the output voltage of the rectifier may be a first output voltage level if a user is using the PRU (e.g., sending a Short Message Service (SMS) message) while the PRU is charging. The output voltage of the rectifier may be a second output if a user is not using the PRU while the PRU is charging. Accordingly, the Power Transmission Unit may adjust the current and/or voltage delivered to the micro-PTU-coil electromagnetically charging the PRU to ensure the current and/or voltage delivered to the coil corresponds to the output voltage of the rectifier.

The PTU may enter a Sub-state 1 410 if a rectifier in and/or on all of the PRUs is within a predefined voltage range. For instance, the PTU may be in Sub-state 1 410 if the voltage and/or current supplied by power amplifier 302a and matching circuit 302b to micro-PTU-coils 304d-f through Impedance Inversions 304a-c and closed switches 306a, 306c, and 306e respectively, produces a voltage in the rectifier of all of the PRUs. The voltage may be restricted between a minimum threshold and a maximum threshold. The thresholds may be based on the operational limits of the rectifier. For example, the voltage in the rectifier may be a function of impedance characteristics of the PRUs, the voltage and/or current through micro-PTU-coils 304d-f, physical, electrical, and/or chemical characteristics of the rectifier, and/or the load on the rectifier due to the power draw from one or more circuits in the PRU.

When PTU is in Sub-state 1 410, Processor(s) 110 may execute one or more computer-executable instructions to actuate power amplifier 302a to adjust the voltage and/or current delivered to Impedance Inversions 304a-c to minimize the absolute difference between the voltage in the rectifier and the preferred rectifier voltage of the one or more PRUs. In particular Processor(s) 110 may adjust the voltage and/or current output from power amplifier 302a such that the current generated in micro-PTU-coils 304d-f by Impedance Inversions 304a-c will minimize the difference between the rectifier voltage and a preferred rectifier voltage of the one or more PRUs. The preferred rectifier voltage may be a value established by the manufacturer, and/or a dynamic value that may change based on the power draw of the PRU. The preferred rectifier voltage may be sent from Processor(s) 148 and 170 via Radio 152 and 174 respectively to Processor(s) 110 via Radio 112 in the advertisement during 405. In other embodiments Processor(s) 110 may adjust the current delivered to micro-PTU-coils 304d-f to maximize the sum of the amount of power received by the PRUs divided by the power delivered by Power Supply 136 to Power Module 134 (Power Module 134 corresponds to Power Module 302 in FIG. 3).

Processor(s) 110 may adjust the current delivered to micro-PTU-coils 304d-f with a step size no greater than a first predetermined value and no less than a second predetermined value. In some embodiments, the first predetermined value may be five percent of the maximum current rating of micro-PTU-coils 304d-f, and the second predetermined value may be no less than one percent of the maximum current rating of micro-PTU-coils 304d-f. In other embodiments, if the rectifier voltage is greater than ninety-five percent of the maximum voltage rating of the rectifier, the step size by which the current in micro-PTU-coils 304d-f is increased may be reduced. The step size, by which the current is reduced, may be based on the type of PRU coupled to micro-PTU-coils 304d-f. For example, PRUs 202a and 206a may have identical maximum voltage rectifier ratings, but the rectifier voltage reported in an advertisement by PRU 202a may be greater than the rectifier voltage reported in an advertisement by PRU 206a. Processor(s) 110 may adjust the current delivered to the coil charging PRU 202a using a greater step size than would be used to adjust the current delivered to the coil charging PRU 206a.

Processor(s) 110 may adjust the step size by which the current delivered to a micro-PTU-coil is reduced if the rectifier voltage of a PRU is less than the one hundred and five percent of the minimum rectifier voltage of the PRU.

Processor(s) 110 may adjust the step size by which the current delivered to a micro-PTU-coil is increased if the current being delivered to the micro-PTU-coil is above the maximum current rating for the micro-PTU-coil and is approaching the maximum value that may be supplied by a power amplifier.

The PTU may enter Sub-state 2 412 if the rectifier voltage of one or more PRUs is less than the minimum rectifier voltage, and the rectifier voltage of each of the one or more PRUs is not greater than the maximum rectifier voltage for the one or more PRUs. If the PTU enters Sub-state 2 412 Processor(s) 110 may increase the current delivered to each micro-PTU-coil with a rectifier voltage less than the minimum rectifier voltage until each PRU coupled to each of the micro-PTU-coils has a rectifier voltage that is greater than or equal to the minimum rectifier voltage. The PTU may increase the current delivered to the micro-PTU-coils such that the rectifier voltage of the PRUs charged by the micro-PTU-coils does not exceed the maximum rectifier voltage, and/or does not cause the PTU to issue a system error warning. Processor(s) 110 may adjust the current delivered to the micro-PTU-coils with a step size not exceeding five percent of the maximum current rating of the micro-PTU-coils and no less than one percent of the maximum current rating of the micro-PTU-coils.

The PTU may enter Sub-State 3 414 if the rectifier voltage of one or more PRUs exceeds the maximum rectifier voltage of the PRU. Processor(s) 110 may adjust the current delivered to the micro-PTU-coils coupled to the PRUs with a rectifier voltage exceeding the maximum rectifier voltage until the rectifier voltage for the PRU is less than or equal to the maximum rectifier voltage. Processor(s) 110 may adjust the current such that the step size with which the current is adjusted is no greater than five percent of the maximum current rating of the micro-PTU-coil and no less than one percent of the maximum current rating of the micro-PTU-coil.

Processor(s) 110 may maintain a timer that counts the amount of time (e.g., minutes, seconds, any fraction of a second), elapsed between when an out-bound wireless communication channel protocol connection is established between the PTU and each of the one or more PRUs. A connection may be established between the PTU and each of the one or more PRUs when, an advertisement is received by Processor(s) 110 from the processors of the one or more PRUs. Processor(s) 110 may start the timers for each of the one or more PRUs. For example, Processor(s) 110 may maintain a timer for PRUs 202a and 206a. Processor(s) 110 may restart a timer for PRUs 202a and 206a when Processor(s) 110 receive an advertisement from Processor(s) 148 and 170 that may be used by PRUs 202a and 206a respectively to send the advertisement. The PTU may reset the timer at 405. In some embodiments, the timer may expire after a predetermined amount of time (i.e., one second). In other embodiments, the expiration of a timer for each PRU may be different from the others. The timer may vary due to the quality of the channel between the PTU and each of the one or more PRUs. For example, the expiration time of a timer for PRU 202a may be greater than the expiration time of a timer for PRU 206a. This may be because the channel between the PTU and PRU 206a may experience more interference than the channel between the PTU and PRU 202a.

If a timer expires before an input power delivered to each of the impedance inversions (i.e., Impedance Inversion 304a-c) varies by a predetermined amount of wattage, Processor(s) 110 may attempt to reconnect with the processors in the one or more PRUs. For example, if Processor(s) 110 maintain a timer for PRU 206a that expires before an input power variation of two watts is experienced by an impedance inversion (i.e., Impedance Inversion 304b) and micro-PTU-coil (i.e., Micro-PTU-coil 304e) that PRU 206a is coupled to, Processor(s) 110 may determine that a connection has been severed. Processor(s) 110 may send one or more messages to Processor(s) 170 in PRU 206a after expiration of the timer to reestablish the connection. If the connection is not reestablished within a predetermined amount of time, Processor(s) 110 may determine that PRU 206a has malfunctioned and the PTU may enter Latching Fault State 418 through 419, and may issue a System Error warning at 417. At 419 the PTU may actuate scanner 302c and matching circuit 302d to send one or more group short beacons, periodic long beacons, and/or group long beacons as explained above and below to determine if a PRU is on micro-PTU-coil 206 or if there is an interfering object on micro-PTU-coil 206.

If the timer maintained by Processor(s) 110 for PRU 206a expires and the variation in power delivered to Impedance Inversion 304c and Micro-PTU-coil 304e is greater than a predetermined amount (e.g., two watts) Processor(s) 110 may clear a registry in Memory 116 associated with Processor(s) 170 as Processor(s) 110 reenters Power Save State 404 through 411. After the registry is cleared, the PTU may reenter Power Save State 404.

After the PTU determines that a PRU completes its charge in 413, Processor(s) 110 may actuate scanner 302c and matching circuit 302d to send one or more group long beacons, single periodic beacons, and/or group long beacons, in Power Save State 404.

The PTU may enter Local Fault State 416 from Configuration State 402 through 427, Power Save State 404 through 431, Low Power State 406 through 433, or Power Transfer State 408 through 415 for an individual micro-PTU-coil if the over-temperature, over-current, over-voltage exceeds and/or drops below a predetermined amount. The PTU may implement an over-temperature protection (i.e., adjust the power delivered to the micro-PTU-coil), to keep the temperature of the PTU within a certain limit. The PTU may implement an over-current protection (i.e., adjust the current delivered to the micro-PTU-coil), to keep the current in a micro-PTU-coil within a certain limit. The PTU may implement an over-voltage protection (i.e., adjust the voltage delivered to the micro-PTU-coil), to keep the voltage across a micro-PTU-coil within a certain limit. If Processor(s) 110 determine that over-temperature exceeds a certain amount, the over-current exceeds or drops below a certain amount, and/or the over-voltage exceeds or drops below a certain amount Processor(s) 110 may place the micro-PTU-coil in Local Fault State 416. If the PTU is charging a micro-PTU-coil in Power Transfer State 408, and Processor(s) 110 determines that the temperature, current, and/or voltage exceeds or drops below certain limits, Processor(s) 110 may actuate a switch connecting power amplifier 302a to the micro-PTU-coil to disable voltage and/or current from being delivered to it. Processor(s) 110 may then close a switch, connecting scanner 302c to the micro-PTU-coil in order to send a group short beacon, periodic long beacons, and/or group long beacons after it places the PTU in Local Fault State 416.

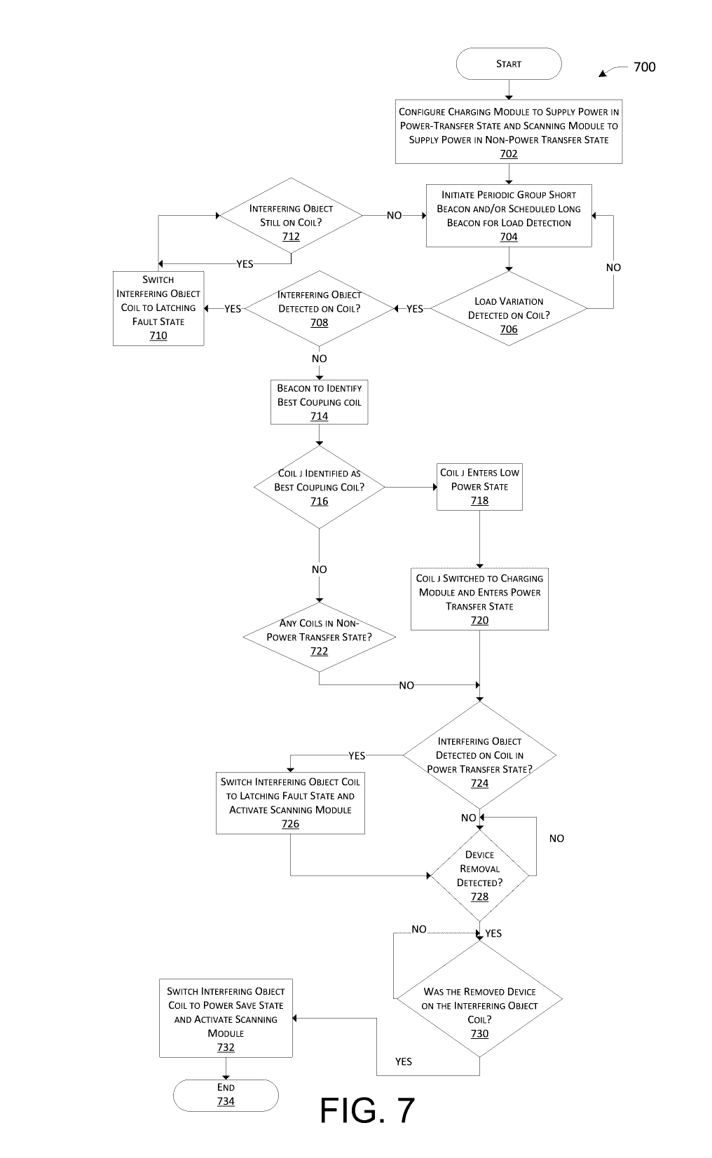

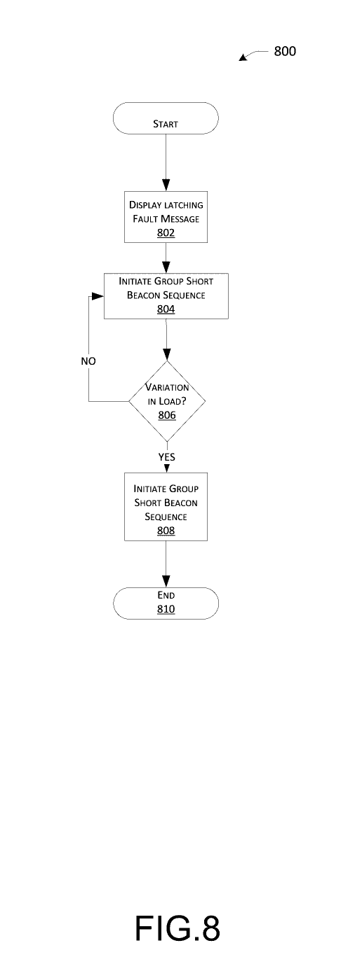

The PTU may enter Latching Fault State 418 from Power Save State 404 through 435, Low Power State 406 through 437 or Power Transfer State 408 through 419 for an individual micro-PTU-coil. The PTU may enter Power Transfer State 408 from Low Power State 406 through 409. The PTU may enter Latching Fault State 418 if an interfering object is detected on the micro-PTU-coil, of if there is an over-temperature, over-current, and/or over-voltage experienced by the PRU coupled to the micro-PTU-coil. The over-temperature, over-current, and/or over-voltage experienced by a PRU may be similar to the over-temperature, over-current, and/or over-voltage experienced by a PTU. An interfering object may be detected as explained in the example above in FIG. 2, and using the method disclosed in FIG. 7.

The PTU may enter Latching Fault State 418, from Local Fault State 416, through 421 when a local fault of an individual micro-PTU-coil is cleared, and the PRU is still on the micro-PTU-coil (with or without an interfering object). A local fault of an individual micro-PTU-coil may be cleared when, for example, an over-temperature, over-current, and/or over-voltage associated with a micro-PTU-coil is adjusted so that they do not exceed or drop below a certain value. The PTU may enter Local Fault State 416, from Latching Fault State 418, through 423 when a latching fault of a PRU is cleared, and there is a local fault on an individual micro-PTU-coil. A latching fault of PRU is cleared when, for example, an over-temperature, over-current, and/or over-voltage associated with the PRU is adjusted so that they do not exceed or drop below a certain value. The PTU may enter Configuration State 402 or Power Save State 404 from Latching Fault State 418, through 413 if all PRUs are removed from the micro-PTU-coils of the PTU, and if none of the micro-PTU-coils have been placed in a local fault state. The PTU may enter either of these states depending on the implementation of the PTU. In some embodiments, the PTU may enter Configuration State 402 from Latching Fault State 418 if Processor(s) 110 determine that one or more components of the PTU should be reset. For example, Processor(s) 110 may determine that one or more registries must be cleared in Memory 116 before the PTU can reenter Power Save State 404. In other embodiments, the PTU may enter Power Save State 404 from Latching Fault State 418 if Processor(s) 110 determine that a registry does not need to be cleared. The PTU may enter Configuration State 402 from Local Fault State 416 through 429 if a micro-PTU-coil is placed in a local fault state, and is cleared when a user removes a PRU from the micro-PTU-coil that was placed in the local fault state.

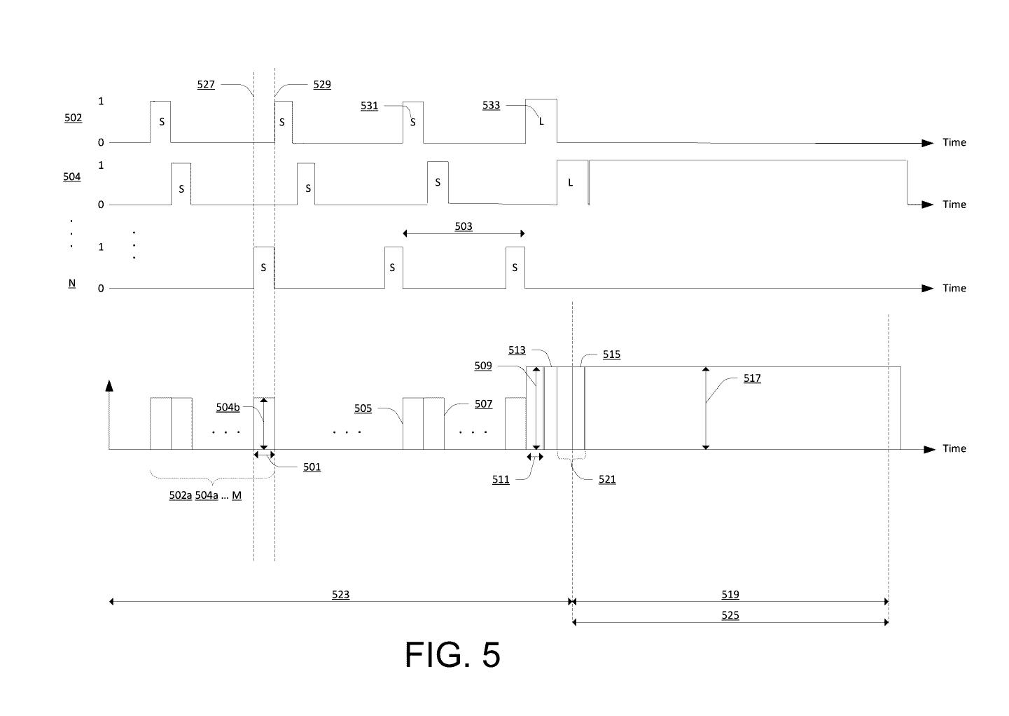

FIG. 5 is an illustrative sequence diagram of an example group short beacon sequence for detecting load variation, in accordance with certain example embodiments of the disclosure. A group short beacon sequence (e.g., group short beacon sequence 502a, 504a, . . . M) may be generated by scanner 302c and may be properly routed to one or more micro-PTU-coils 304d, 304e, and/or 304f via matching circuit 302d. Matching circuit 302d may open and/or close switches 306b, 306d, and/or 306f based on one or more control signals received from one or more processors (i.e., processor(s) 110) in a PTU (i.e., PTU 300). The group short beacon sequence for detecting a load variation may be performed by a PTU (e.g., PTU 300), and more particularly by a scanning module (e.g., scanner 302c). Switches 502, 504, . . . , N, may be closed in serial as explained above and as illustrated in FIG. 5. When switches 502, 504, . . . , N are closed, a scanning module (e.g., scanning module 302f) may send a group short beacon sequence (i.e., group short beacon sequence 502a, 504a, . . . , M) to one or more impedance inversions (e.g., impedance inversion 304a, 304b, and/or 304c). Each beacon in the group short beacon sequence may be a current waveform with predetermined amplitude (i.e., I_{SHORT}_{_}_{BEACON} 504b). In some embodiments, the predetermined amplitudes, of the current waveforms, may be the same. In other embodiments, the predetermined amplitudes, of the current waveforms, may not be the same. When switches 502, 504, . . . , N are in a closed state, the state of the switches may be represented by a logical value of “1”. When switches 502, 504, . . . , N are in an open state, the state of the switches may be represented by a logical value of “0”. A short beacon (e.g., short beacon 531) may be represented by a logical value of “1” and alphabetic value “S”. The duration of the current waveforms may be a predetermined length of time (i.e., t_{SHORT} 501). In some embodiments, the duration, of the current waveforms, may be the same. In other embodiments, the duration, of the current waveforms, may not be the same. A cycle may be defined as the period of time that elapses between when a switch (e.g., switch 502) is closed, opened, and reclosed (i.e., t_{CYCLE} 503). When a load (i.e., one or more PRUs) is detected (i.e., load detected 505 and load detected 507) by a PTU (e.g., PTU 300), group long beacon may be sent from a scanning module (e.g., scanning module 302f) to one or more impedance inversions (e.g., impedance inversion 304a, 304b, and/or 304c). After the scanning module sends the group long beacon, the PTU may determine the best micro-PTU-coil(s) to couple the load. As explained above, the PTU may receive a message from one or more PRUs indicating which micro-PTU-coils provide the strongest magnetic coupling. The strongest magnetic coupling may be determined by the PRU as being the one inducing the greatest electromotive force (voltage) and or current in a micro-PTU-coil in and/or on the one or more PRUs. The PTU may receive this information in a message from the one or more PRUs over a wireless link using the Bluetooth Low Energy protocol.

A long beacon (e.g., long beacon 533) may be represented by a logical value of “1” and alphabetic value “L”. Each of the long beacons in the group long beacon may be a current waveform with predetermined amplitude (i.e., I_{LONG}_{_}_{BEACON} 509), and may be sent to one or more impedance inversions by the scanning module. The current waveform may be applied to the one or more impedance inversions for a predetermined period of time (t_{LONG}_{_}_{BEACON} 511). The PTU may identify one or more micro-PTU-coils to power on depending on the coupling strength between one or more micro-PTU-coils and PRUs is observed by the PTU, during the periodic long beacon. The PTU may also receive advertisements (i.e., advertisement 513 and advertisement 515) from two PRUs attempting to pair with the PTU. The advertisement may comprise one or more packets that may be used by the PTU and PRUs to establish and/or maintain communication between the PTU and PRUs over an out-of-band wireless communication channel protocol (e.g., Bluetooth Low Energy). In some embodiments, the out-of-band wireless channel protocol may be comprised of a signaling protocol that may enable the PTU and PRUs to communicate with one another through a magnetic flux generated between the micro-PTU-coils on the PTU and the PRUs. For example, when scanner 302c in PTU 300 sends long beacon 521 to one or more micro-PTU-coils (i.e., Micro-PTU-coils 304d-f) in PTU 300, a magnetic flux may be generated between the micro-PTU-coils and one or more resonator coils electrically coupled to the PRUs (i.e., Resonator coils 308a-c). The magnetic flux may be used to send messages between a radio (i.e., 112) coupled to PTU 300 and radios (i.e., Radio 174 and/or Radio 152) coupled to the PRUs. The out-of-band wireless communication channel protocol may be established between a radio electrically coupled to the PTU (i.e., Radio 112) and a radio electrically coupled to the PRUs (i.e., Radio 174 and Radio 152).

Advertisement 515 may be received during long beacon 521 before the PTU enters low power state 519. Advertisement 515 may be received before the PTU enters low power state 519 because during low power state 519 the PTU may register the PRUs. The PTU may register the PRUs during low power state 519 by first sending a current waveform (i.e., I_{TX}_{_}_{START} 517) to one or more micro-PTU-coils in/on the PTU, that are magnetically coupled to the PRUs. The current may generate a magnetic flux in the micro-PTU-coils that will in turn generate a current in the PRUs sufficient to power the radios in the PRUs. Once the radios of the PRUs are powered on, the PRUs may register with the PTU using the out-of-band wireless communication channel protocol. After the PTU receives advertisement 515, PTU may provide a current (i.e., I_{TX}_{_}_{START} 517) to a micro-PTU-coil identified during the periodic long beacon. More particularly, the scanning module (e.g., scanning module 302f) may provide the current to the micro-PTU-coil identified during the long beacon sequence as explained above. When the scanning module begins providing current to the micro-PTU-coil, the PTU may enter low power state 519. Low power state 519 may be the same as power state 406, and is the amount of time elapsed between when long beacon 521 ends (scanning module 302f begins applying current to the identified micro-PTU-coil) and when scanning module 302f stops applying current to the identified micro-PTU-coil. Prior to entering this state, PTU may be in power save state 523. Power save state 523 may be the same as power save state 404, and is the amount of time elapsed between when the PTU is turned on and when long beacon 521 ends. The PTU may also set registration timer 525, which is a period of time during which a PRU may register with the PTU. In some embodiments, registration timer 525 may last the same amount of time as low power state 519.

Time 527 and Time 529 may indicate the relationship between the states of switches 502, 504 . . . , N (i.e., 1 or 0) and the current waveforms associated with the short beacons and periodic long beacons. For example, Time 527 may correspond to the time at which scanner 302c may begin to generate a short beacon corresponding to a current waveform with amplitude I_{SHORT}_{_}_{BEACON} 504b and duration t_{SHORT} 501, and switch N may be closed so that the short beacon may be delivered to a micro-PTU-coil (e.g., Micro-PTU-coil 304e). Time 529 may correspond to the time at which the scanner may stop generating the short beacon corresponding to the current waveform, and switch N may be opened so that the short beacon is no longer delivered to the micro-PTU-coil.

In some embodiments, a periodic long beacon may be included after the group short beacon sequence in order to detect an impedance change of a small PRU (e.g., wearable device) on one or more micro-PTU-coils of a PTU. The periodic long beacon may be applied at the same time (aligned in time) to all micro-PTU-coils on the PTU. The periodic long beacon may be aligned in time as opposed to serial and/or parallel, to reduce the amount of time spent to locate the small PRU. The combined group short beacon sequence followed and periodic long beacon or may not have the same periodicity/cycle as the group short beacon in FIG. 5. If a small PRU is detected during the periodic long beacon, a group long beacon is scheduled immediately after the periodic long beacon, and power may be provided to the best micro-PTU-coil(s) to provide power to the small PRU as described above.

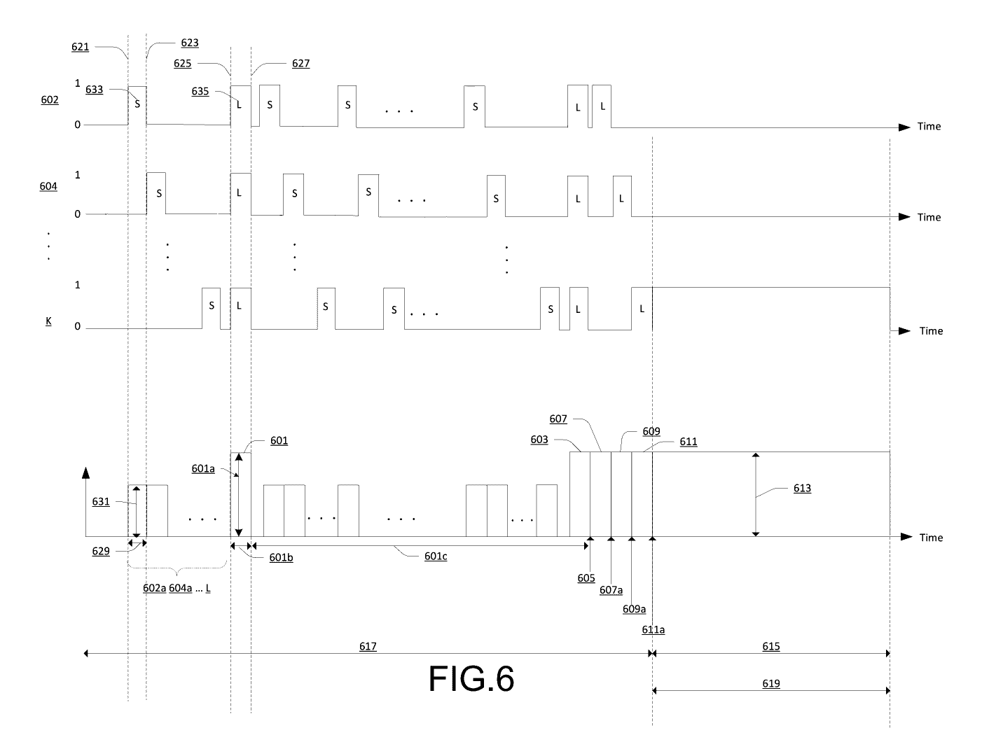

FIG. 6 is an illustrative sequence diagram of a long beacon sequence for detecting load variation of small devices, in accordance with certain example embodiments of the disclosure. Switches 602, 604, . . . , K, may be closed in serial to create group short beacon sequence 602a, 604a, . . . , L. Switches 602, 604, . . . , K may be the same as switches 502, 504, . . . , N in FIG. 5. In some embodiments, group short beacon sequence 602a, 604a, . . . , L may be the same as group short beacon sequence 502a, 504a, . . . , M. In other embodiments, group short beacon sequence 602a, 604a, . . . , L may not be the same as group short beacon sequence 502a, 504a, . . . , M. Periodic long beacon 601 may be a current waveform with a predetermined amplitude (i.e., I_{LONG}_{_}_{BEACON}) and may be applied by a scanning module (e.g., scanner 302c) to one or more impedance inversions (impedance inversion 304a, 304b, and/or 304c) for a predetermined period of time (i.e., t_{LONG}_{_}_{BEACON}). In some embodiments, the current waveform may be applied to all micro-PTU-coils at the same time (i.e., aligned), and in other embodiments the current waveform may not be applied at the same time (i.e., non-aligned). Periodic long beacon 601 may have a periodicity (t_{LONG}_{_}_{BEACON}_{_}_{PERIOD}) longer than the amount of time elapsed between when switches 602, 604, . . . , K are opened, closed, and reopened. The periodicity (cycle) of group short beacon sequence 602a, 604a, . . . , L may be the same as group short beacon sequence 502a, 504a, . . . , M's cycle (i.e., I_{CYCLE} 503). If a small PRU is detected by a micro-PTU-coil on the PTU (load variation detection 605), it may be detected when switches 602, 604, . . . , K close. Load variation detection 605 may occur at the end of periodic long beacon 603 and beginning of group long beacon sequence 607, 609, and 611. The period between the end of periodic long beacon 601 and the end of periodic long beacon 603 may be t_{CYCLE} 601c seconds. After group long beacon sequence 607, 609, and 611 advertisement 607a, 609a, and 611a respectively, may be received at the PTU from one or more small PRUs. Advertisements 607a, 609a, and 611a may be the same as advertisement 513 or advertisement 515. In addition, advertisements 607a, 609a, and 611a may also be transmitted using Bluetooth Low Energy or the magnetic flux between the micro-PTU-coils in the charging device and the PRUs as explained above. After the PTU receives advertisement 607a, 609a, and 611a, PTU may provide a current (i.e., I_{IX}_{_}_{START} 613) to a micro-PTU-coil associated with the detected small PRU. More particularly, a scanning module (e.g., scanning module 302f) may provide current to the micro-PTU-coil identified after group long beacon sequence 607, 609, and 611. Low power state 615 may be the same as low power state 406, and is the amount of time elapsed between advertisement 611a (scanning module 302f begins applying current to a micro-PTU-coil identified during the group long beacon) and when scanning module 302f stops applying current to the identified micro-PTU-coil. Prior to entering this state, PTU may be in power save state 617. Power save state 617 may be the same as power save state 404, and is the amount of time elapsed between when the PTU is turned on and when periodic long beacon 609, of group long beacon sequence 607, 609, and 611, ends. The PTU may also set registration timer 619, which is a period of time during which a PRU may register with the PTU. In some embodiments, registration timer 619 may last the same amount of time as low power state 615.

Time 621 and Time 623 may indicate the relationship between the states of switches 602, . . . , K (i.e., logical values of “1” or “0”) and the current waveforms associated with the short beacons and long beacons. A short beacon (e.g., short beacon 633) may be represented by a logical value of “1” and alphabetic value “S”. For example, Time 621 may correspond to the time at which scanner 302c may begin to generate a short beacon corresponding to a current waveform with amplitude I_{SHORT}_{_}_{BEACON} 631 and duration t_{SHORT} 629, and switch N may be closed so that the short beacon may be delivered to a micro-PTU-coil (e.g., Micro-PTU-coil 304e). Time 623 may correspond to the time at which the scanner may stop generating the short beacon corresponding to the current waveform, and switch N may be opened so that the short beacon is no longer delivered to the micro-PTU-coil. The letter “S” may indicate that a switch is closed between a first time (e.g., Time 621) and second time (e.g., Time 623) to route a short beacon from the scanner to the micro-PTU-coil.

Time 625 and Time 627 may indicate the relationship between the states of switches 602, . . . , K (i.e., logical values of “1” or “0”) and the current waveforms associated with the short beacons and long beacons. A long beacon (e.g., long beacon 635) may be represented by a logical value of “1” and alphabetic value “L”. For example, Time 625 may correspond to the time at which scanner 302c may begin to generate a periodic long beacon corresponding to a current waveform with amplitude I_{LONG}_{_}_{BEACON} 601a and duration t_{LONG} 601b, and switch K may be closed so that the short beacon may be delivered to a micro-PTU-coil (e.g., Micro-PTU-coil 304e). Time 627 may correspond to the time at which the scanner may stop generating the periodic long beacon corresponding to the current waveform, and switch N may be opened so that the short beacon is no longer delivered to the micro-PTU-coil. The letter “L” may indicate that a switch is closed between a first time (e.g., Time 625) and second time (e.g., Time 627) to route a periodic long beacon from the scanner to the micro-PTU-coil.

FIG. 7 is a flow diagram illustrating an example dataflow of method 700 for beacon sequence diagrams of FIGS. 5 and 6, in accordance with certain example embodiments of the disclosure. In step 702 a PTU (e.g., PTU 300) may configure a first matching circuit (e.g., matching circuit 302b) as the power supplier to one or more resonator modules (e.g., resonator modules 304) in a power-transfer state. The PTU may also configure a second matching circuit (e.g., matching circuit 302d) to scan one or more micro-PTU-coils (e.g., 304d, 304e, and 304f) associated with one or more resonator modules (e.g., resonator modules 304) in a non-power transfer state. In step 704, the PTU initiates periodic group short beacons and/or a periodic long beacon for load detection. In step 706, the PTU may determine if one or more micro-PTU-coils associated with the PTU have detected a load variation. A load variation may occur when one or more PRUs come in proximity with the PRU. For example, if one or more of the PRUs are placed on a table with a PTU embedded inside, and the PTU detects a change in reactance and/or impedance then a variation of the load may have occurred. In particular, and as explained above, scanner 302c may detect a variation in load after initiating the periodic group short beacon and/or periodic long beacon, in step 704. The PTU may detect a load variation by measuring the reactance and/or impedance of one or more micro-PTU-coils (e.g., micro-PTU-coil 304d, 304e, and/or 304f) in the PTU (e.g., PTU 300). If a variation in load has been detected the method may proceed to step 708. If a variation in load is not detected in step 706, the method may return to step 704.

The PTU may determine if an interfering object has been detected, in step 706, by initiating a group short beacon, and detecting a variation in the load experienced by one or more impedance inversions (e.g., impedance inversion 304a, 304b, and/or 304c). The group short beacon (e.g., group short beacon sequence 502a, 504a, 506a . . . M) may comprise one or more current waveforms, generated by scanner 302c and applied to one or more impedance inversions (e.g., impedance inversion 304a, 304b, and/or 304c). The one or more impedance inversions may apply a current to the one or more micro-PTU-coils (e.g., micro-PTU-coil 304d, 304e, and/or 304f) on/in the PTU, which in turn may generate a magnetic field in the one or more micro-PTU-coils. When one or more objects, with one or more coils, are brought into physical proximity with the charging area, such as charging area 130 in FIG. 1, of the PTU, the one or more micro-PTU-coils may detect a change in the impedance inversions. When the group short beacon is applied to the impedance inversions, which in turn applies a first current to the one or more micro-PTU-coils, of the PTU, the one or more micro-PTU-coils may generate a first time varying magnetic field. The first time varying magnetic field may be time varying with respect to each current waveform and may have the same periodicity as the cycle of one of the current waveforms in the group short beacon (e.g., t_{CYCLE} 503). The first time varying magnetic field in turn may generate a first magnetic flux in the one or more objects as described above with respect to PRUs 202a and 206a in FIG. 2. The first magnetic flux in the coils of the one or more objects may in turn generate a first electromotive force (EMF) in the coils of the one or more objects. The first EMF may induce a current in the coils of the one or more objects, which may in turn generate a second magnetic field. The second magnetic field may induce a second magnetic flux in the one or more micro-PTU-coils of the PTU. The second magnetic flux may in turn generate a second EMF. The second EMF may generate a second current in the one or more micro-PTU-coils of the PTU. The second current in the one or more micro-PTU-coils of the PTU may change the impedance of the one or more micro-PTU-coils of the PTU, and may be detected by the one or more impedance inversions. The impedance of the one or more micro-PTU-coils of the PTU may have a first impedance, when the first current is applied to the one or more micro-PTU-coils of the PTU. The impedance of the one or more micro-PTU-coils of the PTU may have a second impedance, when the second current is induced in the one or more micro-PTU-coils of the PTU in response to the second EMF. The impedance may be a measure of the reactance and resistance of the one or more micro-PTU-coils in the PTU. In particular, the impedance inversion may detect a change in the reactance of the one or more micro-PTU-coils' capacitive and inductive elements (e.g., Micro-PTU-coil 304d, 304e, and 304f). In addition, the impedance inversion may detect a change in the resistance of the one or more micro-PTU-coils. If the change in impedance corresponds to a predetermined change, the PTU may determine that a load has been detected. The predetermined change in impedance may correspond to the impedance exceeding a predetermined threshold. The threshold may be a function of the sensitivity of the one or more micro-PTU-coils, and may be adjusted depending on the types of PRUs a user may want to charge and/or may not want to charge.

If the PTU detects a change in impedance exceeding the predetermined threshold, the PTU may determine whether a non-wireless chargeable interfering object is within physical proximity of the one or more micro-PTU-coils of the charging area of the PTU (step 708). If one or more interfering objects are detected in step 708, the method may proceed to step 710 and the PTU may switch the one or more micro-PTU-coils with interfering objects on them, into a latching fault state. The method may then proceed to step 712. In step 712, the method may determine if the one or more interfering objects are still proximate to one or more micro-PTU-coils. If no interfering objects are detected on the one or more micro-PTU-coils, the method may progress to step 704. If the one or more interfering objects are still on the one or more micro-PTU-coils, the method may return to step 712. The method may only return to step 712 a predetermined number of times. In some embodiments, the predetermined number of times may be three. If the method returns to step 712 the predetermined number of times, the method may proceed to step 802 of subroutine 800.

Subroutine 800 may be considered a subroutine of step 712. In step 802, the PTU may display a latching fault state message, on a display, instructing a user to remove the one or more interfering objects from the one or more micro-PTU-coils. In some embodiments, the message may be displayed on a display of the one or more non-interfering devices. After step 802, the PTU may initiate a group short beacon sequence to detect a variation in the load of the micro-PTU-coils in the latching fault state (step 804). The subroutine may then proceed to step 806, where the method may determine if there is a variation in the load on the one or more micro-PTU-coils. A variation in the load of the one or more micro-PTU-coils may indicate that the one or more interfering objects have been removed from one or more micro-PTU-coils. If a variation in the load is not detected, then the one or more interfering objects may not have been removed, and the subroutine may return to step 804. The subroutine may continue to return to step 804 until a load variation is detected. The one or more micro-PTU-coils may remain in the latching fault state, and the latching fault state message may continue to be displayed on the display. If a variation in the load is detected, then the one or more interfering objects may have been removed from the respective micro-PTU-coils, and the latching fault message may no longer be displayed on the display of the PTU and/or the one or more non-interfering devices. After a load variation has been detected in step 806, the subroutine may progress to step 808. In step 808, the PTU may place the micro-PTU-coils, with interfering objects proximate to them, in a power save state. The subroutine may end in step 810. Returning to step 712 of FIG. 7 after subroutine 800 ends, the method may progress to step 704 and initiate a periodic group short beacon and/or periodic long beacon for load detection.

Returning to step 708, if no interfering objects are detected on the one or more micro-PTU-coils, the method may progress to step 714. In step 714, the PTU initiates a group long beacon for micro-PTU-coils not covered by an interfering object to identify the best coupling micro-PTU-coil. After step 714, the method may proceed to step 716 and may cycle through all available micro-PTU-coils. If a micro-PTU-coil is determined to be the best micro-PTU-coil, then the method may proceed to step 718. One or more micro-PTU-coils may be determined to be the best based on the location of the one or more micro-PTU-coils relative to a PRU, and the strength of the magnetic coupling between the one or more micro-PTU-coils and PRU as explained above. If a micro-PTU-coil is determined not to be the best micro-PTU-coil, the method may proceed to step 722. If the method proceeds to step 718, the selected micro-PTU-coil is placed in a low power state by the PTU. After the micro-PTU-coil is placed into a low power state, the method may proceed to step 720. In step 720, the micro-PTU-coil may enter a power transfer state. The method may proceed to step 724.

In step 722, the method may determine if there are any remaining micro-PTU-coils in a non-power transfer state. If a micro-PTU-coil is in a non-power transfer state, the method may return to step 704. If the micro-PTU-coil is not in a non-power transfer state, the method may proceed to step 724. In step 724, the method determines if there is an interfering object on any of the micro-PTU-coils during the power transfer state. If there are interfering objects detected on a micro-PTU-coil in the power transfer state, the method may proceed to step 726 where the affected micro-PTU-coil enters a latching fault state. Further, in step 726 the method may disable a first matching circuit (i.e., matching circuit 302b) and may enable a second matching circuit (i.e., matching circuit 302d). The method may then proceed to step 728 to determine if a device removal has been detected.

If a device has not been removed from the micro-PTU-coil, the method may return to step 728. If a PRU has been removed from any of the micro-PTU-coils, the method may determine if the PRU was removed from the micro-PTU-coil with the interfering object on it. If the PRU was the PRU on the micro-PTU-coil with the interfering object on it, the method may proceed to step 730. In step 730, the method may determine if the interfering object, in step 726, has been removed from the micro-PTU-coil. If the interfering object has not been removed from the micro-PTU-coil, the method may return to step 730. If the interfering object has been removed from the micro-PTU-coil, the method may proceed to step 732. In step 732 the method may put the first matching circuit (i.e., matching circuit 302b) into a power save state and may enable the second matching circuit (i.e., matching circuit 302d) to begin scanning for a load variation. After step 732, the method may end (step 734).

Embodiments described herein may be implemented using hardware, software, and/or firmware, for example, to perform the methods and/or operations described herein. Certain embodiments described herein may be provided as one or more tangible machine-readable media storing machine-executable instructions that, if executed by a machine, cause the machine to perform the methods and/or operations described herein. The tangible machine-readable media may include, but is not limited to, any type of disk including floppy disks, optical disks, compact disk read-only memories (CD-ROMs), compact disk rewritable (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware. Additionally, in certain embodiments, a special-purpose computer or a particular machine may be formed in order to identify actuated input elements and process the identifications.

Various embodiments of the disclosure may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

In example embodiments of the disclosure, there may be a power transfer device. The power transfer device may include a plurality of micro-PTU-coils; at least one memory that stores computer-executable instructions; and at least one processor configured to access the at least one memory, wherein the at least one processor is configured to execute the computer-executable instructions to cause to send a group short beacon signal to the plurality of micro-PTU-coils. The power transfer device may identify a load on a first micro-PTU-coil of the plurality of micro-PTU-coils using a detected magnetic flux caused by an object being proximate to the first micro-PTU-coil. The power transfer device may determine a location of the object using the identified load on the first micro-PTU-coil. The power transfer device may cause to send a group long beacon signal to the plurality of micro-PTU-coils. The power transfer device may receive, from the object, an advertisement, the advertisement comprising an indication of a coupling strength between the first micro-PTU-coil and the object. The power transfer device may determine that the object is an electronic device. The power transfer device may determine to apply a current to the first micro-PTU-coil using the location of the electronic device and the coupling strength data.

Implementations may include one or more of the following features. The at least one processor may be further configured to execute the computer-executable instructions to identify a second load on a second micro-PTU-coil of the plurality of micro-PTU-coils using a second detected magnetic flux caused by a second object being proximate to the second micro-PTU-coil; determine a second location of the second object using the identified second load on the second micro-PTU-coil; determine that the second object is an interfering object using the second location of the object and the second detected magnetic flux; cause the power transfer device to send one or more second periodic short beacons signal to the second micro-PTU-coil; detecting a change in the second detected magnetic flux; and determining the second object is removed from the second location using the change in the second detected magnetic flux. The at least one processor may be further configured to execute the computer-executable instructions to determine if a strength of the detected magnetic flux satisfies a threshold by measuring a first change in an impedance of the first micro-PTU-coil from the detected magnetic flux induced in the first micro-PTU-coil by the electronic device. The at least one processor may be further configured to execute the computer-executable instructions to determine a change in strength of the detected magnetic flux; and determine the electronic device is removed from the location. The at least one processor may be further configured to execute the computer-executable instructions to determine a third object has been placed proximate to the first micro-PTU-coil when the electronic device is at the location using a change in the detected magnetic flux. The power transfer device may further include a wireless radio, wherein the advertisement is received over an out-of-band wireless communication channel by the wireless radio. The out-of-band wireless communication channel in some embodiments may be a Bluetooth Low Energy Protocol channel. The advertisement may comprise one or more output voltage values associated with a voltage rectifier in the electronic device. The power transfer device may further include a power amplifier and scanner. The at least one processor may be further configured to execute the computer-executable instructions to cause the power amplifier to apply the current to the first micro-PTU-coil to charge the electronic device. The at least one processor may be further configured to execute the computer-executable instructions to cause the scanner to send the group long beacon signal to the plurality of micro-PTU-coils to determine the first micro-PTU-coil to couple to the electronic device.

In example embodiments of the disclosure, there may be a non-transitory computer-readable medium. The non-transitory computer-readable medium may store computer-executable instructions which, when executed by a processor result in performing operations comprising: causing a power transfer device to send a group short beacon signal to a plurality of micro-PTU-coils; identifying a load on a first micro-PTU-coil of the plurality of micro-PTU-coils using a detected magnetic flux caused by an object being proximate to the first micro-PTU-coil; determining a location of the object using the identified load on the first micro-PTU-coil; causing the power distribution device to send a group long beacon signal to the plurality of micro-PTU-coils; receiving, from the object, an advertisement, the advertisement comprising an indication of a coupling strength between the first micro-PTU-coil and the object; determining that the object is an electronic device; and determining to cause to apply a current to the first micro-PTU-coil using the location of the electronic device and the coupling strength data; and applying the current to the first micro-PTU-coil.

Implementations may include one or more of the following features. The computer-executable instructions may cause the processor to further perform operations including identifying a second load on a second micro-PTU-coil of the plurality of micro-PTU-coils using a second detected magnetic flux caused by a second object being proximate to the second micro-PTU-coil; determining a second location of the second object using the identified second load on the second micro-PTU-coil; determining that the second object is an interfering object using the second location of the object and the second detected magnetic flux; the power distribution device to send one or more second periodic short beacon signals to the second micro-PTU-coil; detecting a change in the second detected magnetic flux; and determining the second object is removed from the second location using the change in the second detected magnetic flux. The computer-executable instructions may cause the processor to further perform operations including determining a change in strength of the detected magnetic flux; and determining the electronic device is removed from the location. The computer-executable instructions may cause the processor to further perform operations including determining that a third object has been placed proximate to the first micro-PTU-coil when the electronic device is at the location using a change in the magnetic flux. The computer-executable instructions may cause the processor to further perform operations including causing a power amplifier to apply the current to the first micro-PTU-coil to charge the electronic device. The computer-executable instructions may cause the processor to further perform operations including causing a scanner to send the group long beacon signal to the plurality of micro-PTU-coils to determine the first micro-PTU-coil to couple to the electronic device.

In example embodiments of the disclosure, there may be a method. The method may include causing a power distribution device to send a group short beacon signal to a plurality of micro-PTU-coils; identifying a load on a first micro-PTU-coil of the plurality of micro-PTU-coils using a detected magnetic flux caused by an object being proximate to the first micro-PTU-coil; determining a location of the object using the identified load on the first micro-PTU-coil; causing the power distribution device to send a group long beacon signal to the plurality of micro-PTU-coils; receiving, from the object, an advertisement, the advertisement comprising an indication of a coupling strength between the first micro-PTU-coil and the object; determining that the object is an electronic device; and determining to apply a current to the first micro-PTU-coil using the location of the electronic device and the coupling strength data.

Implementations may include one or more of the following features. The method may include determining a strength of the detected magnetic flux; and determining the electronic device is removed from the location. The method may further include determining a third object has been placed proximate to the first micro-PTU-coil when the electronic device is at the location using a change in the detected magnetic flux. The method may further include causing a power amplifier to apply the current to the first micro-PTU-coil to charge the electronic device. The method may further include causing a scanner to send the group long beacon signal to the plurality of micro-PTU-coils to determine the first micro-PTU-coil to couple to the electronic device.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

The claimed disclosure is:

1. A power transfer device comprising:
a plurality of micro-PTU-coils;
at least one memory that stores computer-executable instructions; and
at least one processor configured to access the at least one memory, wherein the at least one processor is configured to execute the computer-executable instructions to:
cause to send a group short beacon signal to the plurality of micro-PTU-coils;
identify a load on a first micro-PTU-coil of the plurality of micro-PTU-coils using a detected magnetic flux caused by an object being proximate to the first micro-PTU-coil;
determine a location of the object using the identified load on the first micro-PTU-coil;
cause to send a group long beacon signal to the plurality of micro-PTU-coils;
receive, from the object, an advertisement, the advertisement comprising an indication of a coupling strength between the first micro-PTU-coil and the object;
determine that the object is an electronic device; and
determine to apply a current to the first micro-PTU-coil using the location of the electronic device and the coupling strength data.

2. The power transfer device of claim 1, wherein the at least one processor is further configured to execute the computer-executable instructions to:
identify a second load on a second micro-PTU-coil of the plurality of micro-PTU-coils using a second detected magnetic flux caused by a second object being proximate to the second micro-PTU-coil;
determine a second location of the second object using the identified second load on the second micro-PTU-coil;
determine that the second object is an interfering object using the second location of the object and the second detected magnetic flux;
cause to send one or more second periodic short beacon signals to the second micro-PTU-coil;
detecting a change in the second detected magnetic flux; and
determining the second object is removed from the second location using the change in the second detected magnetic flux.

3. The power transfer device of claim 1, wherein the at least one processor is further configured to execute the computer-executable instructions to determine if a strength of the detected magnetic flux satisfies a threshold by measuring a first change in an impedance of the first micro-PTU-coil from the detected magnetic flux induced in the first micro-PTU-coil by the electronic device.

4. The power transfer device of claim 1, wherein the at least one processor is further configured to execute the computer-executable instructions to:
determine a change in strength of the detected magnetic flux; and
determine the electronic device is removed from the location.

5. The power transfer device of claim 4, wherein the at least one processor is further configured to execute the computer-executable instructions to determine a third object has been placed proximate to the first micro-PTU-coil when the electronic device is at the location using a change in the detected magnetic flux.

6. The power transfer device of claim 1, further comprising a wireless radio, wherein the advertisement is received over an out-of-band wireless communication channel by the wireless radio.

7. The power transfer device of claim 6, wherein the out-of-band wireless communication channel is a Bluetooth Low Energy Protocol channel.

8. The power transfer device of claim 7, wherein the advertisement further comprises one or more output voltage values associated with a voltage rectifier in the electronic device.

9. The power transfer device of claim 1, further comprising a power amplifier and a scanner.

10. The power transfer device of claim 9, wherein the at least one processor is further configured to execute the computer-executable instructions to cause the power amplifier to apply the current to the first micro-PTU-coil to charge the electronic device.

11. The power transfer device of claim 9, wherein the at least one processor is further configured to execute the computer-executable instructions to cause the scanner to send the group long beacon signal to the plurality of micro-PTU-coils.

12. A non-transitory computer-readable medium storing computer-executable instructions which, when executed by a processor, cause the processor to perform operations comprising:
causing a power distribution device to send a group short beacon signal to a plurality of micro-PTU-coils;
identifying a load on a first micro-PTU-coil of the plurality of micro-PTU-coils using a detected magnetic flux caused by an object being proximate to the first micro-PTU-coil;
determining a location of the object using the identified load on the first micro-PTU-coil;
causing the power distribution device to send a group long beacon signal to the plurality of micro-PTU-coils;
receiving, from the object, an advertisement, the advertisement comprising an indication of a coupling strength between the first micro-PTU-coil and the object;
determining that the object is an electronic device; and
determining to cause to apply a current to the first micro-PTU-coil using the location of the electronic device and the coupling strength data.

13. The non-transitory computer-readable medium of claim 12, wherein the operations further comprise:
identifying a second load on a second micro-PTU-coil of the plurality of micro-PTU-coils using a second detected magnetic flux caused by a second object being proximate to the second micro-PTU-coil;
determining a second location of the second object using the identified second load on the second micro-PTU-coil;
determining that the second object is an interfering object using the second location of the object and the second detected magnetic flux;
causing the power distribution device to send one or more second periodic short beacon signals to the second micro-PTU-coil;
detecting a change in the second detected magnetic flux; and
determining the second object is removed from the second location using the change in the second detected magnetic flux.

14. The non-transitory computer-readable medium of claim 12, wherein the operations further comprise:
determining a change in strength of the detected magnetic flux; and
determining the electronic device is removed from the location.

15. The non-transitory computer-readable medium of claim 12, wherein the operations further comprise:
determining that a third object has been placed proximate to the first micro-PTU-coil when the electronic device is at the location using a change in the magnetic flux.

16. The non-transitory computer-readable medium of claim 12, wherein the operations further comprise causing a power amplifier to apply the current to the first micro-PTU-coil to charge the electronic device.

17. The non-transitory computer-readable medium of claim 12, wherein the operations further comprise causing a scanner to send the group long beacon signal to the plurality of micro-PTU-coils to determine the first micro-PTU-coil to couple to the electronic device.

18. A method, comprising:
causing a power distribution device to send a group short beacon signal to a plurality of micro-PTU-coils;
identifying a load on a first micro-PTU-coil of the plurality of micro-PTU-coils using a detected magnetic flux caused by an object being proximate to the first micro-PTU-coil;
determining a location of the object using the identified load on the first micro-PTU-coil;
causing the power distribution device to send a group long beacon signal to the plurality of micro-PTU-coils;
receiving, from the object, an advertisement, the advertisement comprising an indication of a coupling strength between the first micro-PTU-coil and the object;
determining that the object is an electronic device; and
determining to apply a current to the first micro-PTU-coil using the location of the electronic device and the coupling strength data.

19. The method of claim 18, further comprising:
determining a strength of the detected magnetic flux; and
determining the electronic device is removed from the location.

20. The method of 18, further comprising:
determining that a third object has been placed proximate to the first micro-PTU-coil when the electronic device is at the location using a change in the detected magnetic flux.

21. The method of claim 18, further comprising:
causing a power amplifier to apply the current to the first micro-PTU-coil to charge the electronic device.

22. The method of claim 18, further comprising:
causing a scanner to send the group long beacon signal to the plurality of micro-PTU-coils to determine the first micro-PTU-coil to couple to the electronic device.
